(19) United States
(12) Patent Application Publication
(10) Pub. No.: US 2016/0379148 A1
(43) Pub. Date: Dec. 29, 2016

(54) System and Methods for Interest-Driven Business Intelligence Systems with Enhanced Data Pipelines

(71) Applicant: Workday, Inc., Pleasanton, CA (US)

(72) Inventors: Hans-Frederick Brown, San Rafael, CA (US); James Mulholland, San Francisco, CA (US); Honray Lin, Mountain View, CA (US); Carl-Christian Kanne, Campbell, CA (US)

(73) Assignee: Platfora, Inc.

(21) Appl. No.: 14/750,504

(22) Filed: Jun. 25, 2015

(51) Int. Cl. G06Q 10/06

(52) U.S. Cl. CPC G06Q 10/06316

(57) ABSTRACT

In accordance with disclosed embodiments of the invention, a business intelligence server system receives telemetry data from an interest-driven business intelligence visualization system. The telemetry data includes an action for manipulating data. The telemetry data for an action is added to current workflow data. The current workflow data includes a sequential list of actions performed on the data. The current workflow data is compared to stored workflow data. One or more possible subsequent actions to perform on the data are determined based upon the comparison of the current workflow data to stored workflow data that includes workflow data for multiple workflows, and provides the one or more possible subsequent actions to perform on the data to the interest-driven business intelligence visualization system.

### FIELD OF THE INVENTION

The present invention is generally related to business intelligence systems and more specifically to processing data in business intelligence systems.

### BACKGROUND

The term “business intelligence” is commonly used to refer to techniques for identifying, processing, and analyzing business data. Business intelligence systems can provide historical, current, and predictive views of business operations. Business data, generated during the course of business operations, including data generated from business processes and the additional data created by employees and customers, can be structured, semi-structured, or unstructured depending on the context and knowledge surrounding the data. In many cases, data generated from business processes is structured, whereas data generated from customer interactions with the business is semi-structured or unstructured. Due to the amount of data generally generated during the course of business operations, business intelligence systems are commonly built on top of and utilize a data warehouse.

Data warehouses are utilized to store, analyze, and report data such as business data. Data warehouses utilize databases to store, analyze, and harness the data in a productive and cost-effective manner. A variety of databases are commonly utilized including a relational database management system (RDBMS), such as the Oracle Database from the Oracle Corporation of Santa Clara, Calif., or a massively parallel processing analytical database, such as Teradata from the Teradata Corporation of Miamisburg, Ohio. Business intelligence (BI) and analytical tools, such as SAS from SAS Institute, Inc. of Cary, N.C., are used to access the data stored in the database and provide an interface for developers to generate reports, manage and mine the stored data, perform statistical analysis, business planning, forecasting, and other business functions. Most reports created using BI tools are created by database administrators and/or business intelligence specialists, and the underlying database can be tuned for the expected access patterns. A database administrator can index, pre-aggregate or restrict access to specific relations, allow ad-hoc reporting and exploration.

A snowflake schema is an arrangement of tables in a RDBMS, with a central fact table connected to one or more dimension tables. The dimension tables in a snowflake schema are normalized into multiple related tables. For a complex schema, there will be many relationships between the dimension tables resulting in a schema that looks like a snowflake. A star schema is a specific form of a snowflake schema having a fact table referencing one or more dimension tables. However, in a star schema, the dimensions are normalized into a single table—the fact table is the center and the dimension tables are the “points” of the star.

Online transaction processing (OLTP) systems are designed to facilitate and manage transaction-based applications. OTLP can refer to a variety of transactions such a database management system transactions, business, or commercial transactions. OLTP systems typically have low latency response to user requests.

Online analytical processing (OLAP) is an approach to answering multidimensional analytical queries. OLAP tools enable users to analyze multidimensional data utilizing three basic analytical operations: consolidation (aggregating data), drill-down (navigating details of data), and slice and dice (take specific sets of data and view from multiple viewpoints). The basis for many OLAP systems is an OLAP cube. An OLAP cube is a data structure allowing for fast analysis of data with the capability of manipulating and analyzing data from multiple perspectives. OLAP cubes are typically composed of numeric facts, called measures, categorized by dimensions. These facts and measures are commonly created from a star schema or a snowflake schema of tables in a RDBMS.

### SUMMARY OF THE INVENTION

Systems and methods for interest-driven business intelligence systems with enhanced data pipelines in accordance with embodiments of the invention are illustrated. In accordance with some embodiments of the invention, a business intelligence server system including a processor and memory performs the following processes as directed by the instructions in the memory. The system receives telemetry data from an interest-driven business intelligence visualization system wherein the telemetry data includes an action for manipulating data. The telemetry data for a workflow includes a sequential list of actions performed on the data. The server system compares the current workflow data to stored workflow data and determines one or more possible subsequent actions to perform on the data based upon the comparison of the current workflow data to stored workflow data. The stored workflow data includes workflow data for multiple workflows. The one or more possible subsequent actions to perform on the data are provided to the interest-driven business intelligence visualization system.

In accordance with some embodiments, the determination of the one or more subsequent action in performed in the following manner. The system determines each workflow in the stored workflow data that includes a portion of workflow data that is similar to the current workflow data and determine actions with the workflow data after the portions of workflow data that is similar to the current workflow data. The system provides the subsequent actions in the workflow data of each workflow having a portion of workflow data similar to the current workflow data as a possible subsequent action for the current workflow data. In accordance with some embodiments, the stored workflow data includes workflow data from previous workflows of a user. In accordance with some of these embodiments, the stored workflow data includes workflow data of previous workflows of users associated with the user. In accordance with many embodiments of this invention, the stored workflow data includes workflow data of previous workflows from multiple users. In accordance with a number of embodiments, the one or more subsequent actions are ranked based upon likelihood of use. In accordance with many embodiments, the ranking of each of the one or more subsequent actions is based upon the proximity of each of the one or more subsequent actions in the workflow data of a workflow to a portion of workflow data for the workflow that is similar to the current workflow data. In accordance with a number of embodiments, the ranking of each of the one or more subsequent actions is based upon a number of occurrences of each of the one or more subsequent steps in the stored workflow data.

In accordance with some embodiments, the system further performs the following process. The system determines whether the interaction is a query. If the interaction is a query, the system determines help data accessed by the query in response to a determination that the interaction is a query. The system determines one or more possible subsequent actions to perform on the data based upon the help data accessed by the query, and provide the one or more possible subsequent actions to perform on the data to the interest-driven business intelligence visualization system.

In accordance with some embodiments, the system obtains the stored workflow data from a global workflow database.

### BRIEF DESCRIPTION OF THE DRAWINGS

FIG. 1 is a network diagram of an interest-driven business intelligence system in accordance with an embodiment of the invention.

FIG. 2 is a conceptual illustration of an interest-driven business intelligence server system in accordance with an embodiment of the invention.

FIG. 3 is a conceptual illustration of an interest-driven data visualization system in accordance with an embodiment of the invention.

FIG. 4 is a flow chart illustrating a process for snapshot isolation in an interest-driven data sharing server system in accordance with an embodiment of the invention.

FIG. 5 is a flow chart illustrating a process for iterative reporting data generation in an interest-driven data sharing server system in accordance with an embodiment of the invention.

FIG. 6 is a flow chart illustrating a process for creating segment data in accordance with an embodiment of the invention.

FIG. 7 is a flow chart illustrating a process for creating composite segment data in accordance with an embodiment of the invention.

FIG. 8 is a conceptual diagram of composite segment data obtained from various data segments in accordance with an embodiment of the invention.

FIGS. 9-17 are illustrations of interfaces for generating composite segment data that merges two segments of data in accordance with an embodiment of the invention.

FIG. 18 is a flow chart illustrating a process for generating segment data in accordance with an embodiment of the invention.

FIG. 19 is a flow chart illustrating a process for generating reporting data based on segment data in accordance with an embodiment of the invention.

FIGS. 20-23 are illustrations of interfaces for managing samples of data in accordance with an embodiment of the invention.

FIG. 24 is a flow chart illustrating a process for generating flow data for reporting data in accordance with an embodiment of the invention.

FIGS. 25-31 are illustrations of interfaces for interacting with displays of flow data in accordance with an embodiment of the invention.

FIG. 32 is a flow chart illustrating a process for providing recommendations for a workflow based on telemetry data in accordance with an embodiment of the invention.

FIGS. 33 and 34 are illustrations of user interfaces for using recommendations based on telemetry data in accordance with an embodiment of the invention.

FIGS. 35-40 are illustrations of interfaces for generating composite segment data that merges two segments of data in accordance with an embodiment of the invention.

### DETAILED DISCLOSURE OF THE INVENTION

Turning now to the drawings, interest-driven business intelligence systems configured to utilize segment data in accordance with embodiments of the invention are illustrated. Interest-driven business intelligence systems include interest-driven business intelligence server systems configured to create reporting data using raw data retrieved from distributed computing platforms. The interest-driven business intelligence server systems are configured to dynamically compile interest-driven data pipelines to provide analysts with information of interest from the distributed computing platform. The interest-driven business intelligence server system has the ability to dynamically recompile the interest-driven data pipeline to provide access to desired information stored in the distributed computing platform. An interest-driven data pipeline is dynamically compiled to create reporting data based on reporting data requirements determined by analysts utilizing interest-driven data visualization systems within the interest-driven business intelligence system. Changes specified at the report level can be automatically compiled and traced backward by the interest-driven business intelligence server system to compile an appropriate interest-driven data pipeline to meet the new and/or updated reporting data requirements. Interest-driven business intelligence server systems further build metadata concerning the data available within the interest-driven business intelligence system and provide the metadata to interest-driven data visualization systems to enable the construction of reports using the metadata. In this way, interest-driven business intelligence server systems are capable of managing huge datasets in a way that provides analysts with complete visibility into the available data. Available data within an interest-driven business intelligence system includes any data present within an interest-driven business intelligence server system and/or a distributed computing platform. Interest-driven business intelligence systems and interest-driven business intelligence server systems that can be utilized in accordance with embodiments of the invention are discussed further in U.S. Pat. No. 8,447,721, titled “Interest-Driven Business Intelligence Systems and Methods of Data Analysis Using Interest-Driven Data Pipelines” and filed Feb. 29, 2012, the entirety of which is incorporated herein by reference.

Business intelligence systems, including interest-driven business intelligence systems in accordance with embodiments of the invention are configured to provide segment data that can be explored using interest-driven data visualization systems. In a variety of embodiments, segment data includes data grouped by one or more pieces of segment grouping data. This segment grouping data can be utilized in the exploration of the segment data to quickly identify patterns of interest within the data. The data utilized within the segment data can be sourced from a variety of pieces of data, including source data, aggregate data, event-oriented data, and reporting data as appropriate to the requirements of specific applications in accordance with embodiments of the invention. Additionally, multiple segments can be combined together in order to explore patterns existing across multiple segments for one or more pieces of reporting data. In accordance with some embodiments, one or more data segments can be merged into a composite data segment that includes the data from both sets. In accordance with some other embodiments, one or more common keys in two or more data sets can be used to combine the data from the individual segments into a segment in which the data is in a single domain. Based on patterns identified within the (combined) segment data, specific pieces of reporting data can be generated targeting the identified patterns within the segment data. This reporting data can then be utilized to generate detailed reports for additional analysis and exploration of the patterns located within the (combined) segment data. In a variety of embodiments, metadata describing the (combined) segment data can be stored and utilized to generate updated segment data. This updated segment data can be utilized to further analyze patterns occurring within the reporting data as the underlying reporting data changes.

Reports can be created using interest-driven data visualization systems configured to request and receive data from an interest-driven business intelligence server system. Systems and methods for interest-driven data visualization that can be utilized in accordance with embodiments are described in U.S. Patent Publication No. 2014/0114970, titled “Systems and Methods for Interest-Driven Data Visualization Systems Utilized in Interest-Driven Business Intelligence Systems” and filed Mar. 8, 2013, the entirety of which is hereby incorporated by reference. In order for an interest-driven data visualization system to build reports, a set of reporting data requirements are defined. These requirements specify the reporting data (derived from raw data) that will be utilized to generate the reports. The raw data can be structured, semi-structured, or unstructured. In a variety of embodiments, structured and semi-structured data include metadata, such as an index or other relationships, describing the data; unstructured data lacks any definitional structure. An interest-driven business intelligence server system can utilize reporting data already created by the interest-driven business intelligence server systems and/or cause new and/or updated reporting data to be generated to satisfy the reporting data requirements. In a variety of embodiments, reporting data requirements are obtained from interest-driven data visualization systems based on reporting requirements defined by analysts exploring metadata describing data stored within the interest-driven business intelligence system.

To facilitate the generation of reporting data requirements, the interest-driven intelligence system can generate data flow data regarding the available data. The available data within an interest-driven business intelligence system includes any data present within an interest-driven business intelligence server system and/or a distributed computing platform including, but not limited to raw data, source data, reporting data, event series data, and/or data segments. The data flow data show the relationships in the available data based upon keys that can be used to filter and/or order the data. Interest-driven data visualization systems and/or an interest-driven business intelligence server system can generate visual presentations of the flow data to enable an analyst to analyze the available data in order to generate reporting data requirements.

In accordance with some embodiments of the invention, interest-driven data visualization systems and/or an interest-driven business intelligence server system can capture telemetry data. Telemetry data can include interaction data relating to interactions between a user and the interest-driven business intelligence system and/or event data that relates to changes that occur in the available data. The interactions can include actions that are changes to the reporting requirements, segment grouping data, and/or other types of data for manipulating available data. In accordance with some embodiments, telemetry data for an individual session by a user is stored as a workflow by the interest-driven business intelligence system. The stored workflows can then analyzed and used to generate recommendations of subsequent interactions and/or events in a current workflow on receipt of a new interaction. In accordance with a number of embodiments, the interactions can include queries to help data depending on the help data accessed by the inquiry recommendations to subsequent interactions in the current workflow can be provided.

The data requested in the reporting data requirements can include any of a variety of source data available from an interest-driven business intelligence server system. In a number of embodiments, the raw data, aggregate data, event-oriented data, and/or filtered data can be provided to interest-driven business intelligence server systems as source data. In many embodiments, the source data is described by metadata describing the raw data, aggregate data, event-oriented data, and/or filtered data present in the source data. In several embodiments, the source data, aggregate data, event-oriented data, and/or reporting data is stored in a data mart or other aggregate data storage associated with the interest-driven business intelligence server system. Interest-driven business intelligence server systems can load source data into a variety of reporting data structures in accordance with a number of embodiments, including, but not limited to, online analytical processing (OLAP) cubes. In a variety of embodiments, the reporting data structures are defined using reporting data metadata describing a reporting data schema. In a number of embodiments, interest-driven business intelligence server systems are configured to combine requests for one or more OLAP cubes into a single request, thereby reducing the time, storage, and/or processing power utilized by the interest-driven business intelligence system in creating source data utilized to create reporting data schemas and/or the reporting data.

Interest-driven business intelligence server systems can be configured to provide reporting data based on one or more reporting data requirements. Reporting data provided by interest-driven business intelligence server systems includes raw data, aggregate data, event-oriented data, and/or filtered data loaded from raw data storage that has been processed and loaded into a data structure to provide rapid access to the data. Event-oriented data can include sets of data aligned along one or more of the dimensions of (e.g. columns of data within) the sets of data. Sets of data include, but are not limited to, fact tables and dimension tables as appropriate to the requirements of specific applications in accordance with embodiments of the invention. In this way, event-oriented data can include a variety of data across multiple sets of data that are organized by ordering data. Interest-driven business intelligence systems that are configured to utilize event-oriented data that can be utilized in accordance with embodiments of the invention are discussed further in U.S. Patent Publication No. 2015/0081618, titled “Systems and Methods for Interest-Driven Business Intelligence Systems Including Event-Oriented Data” and filed Mar. 5, 2014, the disclosure of which is hereby incorporated by reference in its entirety.

Although the systems and methods described below incorporate data including facts and dimensions, any of a variety of data, including data with other relationships, can be utilized as appropriate to the requirements of specific applications in accordance with embodiments of the invention. Systems and methods for interest-driven business intelligence systems including segment data in accordance with embodiments of the invention are described below.

### Interest-Driven Business Intelligence Systems

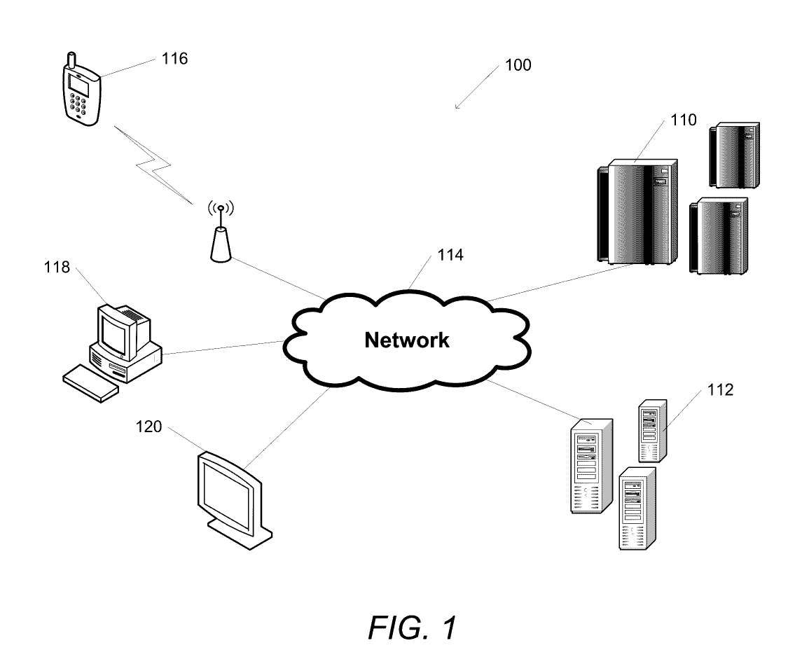

An interest-driven business intelligence system in accordance with an embodiment of the invention is illustrated in FIG. 1. The interest-driven business intelligence system 100 includes a distributed computing platform 110 configured to store raw business data. The distributed computing platform 110 is configured to communicate with an interest-driven business intelligence server system 112 via a network 114. In several embodiments of the invention, the network 114 is a local area network, a wide area network, or the Internet; any network 114 can be utilized as appropriate to the requirements of specific applications in accordance with embodiments of the invention. In a variety of embodiments, the distributed computing platform 110 is a cluster of computing devices configured as a distributed computing platform. The distributed computing platform 110 can be configured to act as a raw data storage system and a data warehouse within the interest-driven business intelligence system. In a number of embodiments, the distributed computing platform includes a distributed file system configured to distribute the data stored within the distributed computing platform 110 across the cluster computing devices. In many embodiments, the distributed data is replicated across the computing devices within the distributed computing platform, thereby providing redundant storage of the data. The distributed computing platform 110 is configured to retrieve data from the computing devices by identifying one or more of the computing devices containing the requested data and retrieving some or all of the data from the computing devices. In a variety of embodiments where portions of a request for data are stored using different computing devices, the distributed computing platform 110 is configured to process the portions of data received from the computing devices in order to build the data obtained in response to the request for data. Any distributed file system, such as the Hadoop Distributed File System (HDFS), can be utilized as appropriate to the requirements of specific applications in accordance with embodiments of the invention. In several embodiments, the interest-driven business intelligence server system 112 is implemented using one or a cluster of computing devices. In a variety of embodiments, alternative distributed processing systems are utilized. Raw data storage is utilized to store raw data, metadata storage is utilized to store data description metadata describing the raw data, and/or report storage is utilized to store previously generated reports including previous reporting data and previous reporting data requirements. Raw data storage, metadata storage, and/or report storage can be a portion of the memory associated with the interest-driven business intelligence server system 112, the distributed computing platform 110, and/or a separate device in accordance with the specific requirements of specific embodiments of the invention.

The interest-driven business intelligence server system 112 is configured to communicate via the network 114 with one or more interest-driven data visualization systems, including, but not limited to, cellular telephones 116, personal computers 118, and presentation devices 120. In many embodiments of the invention, interest-driven data visualization systems include any computing device capable of receiving and/or displaying data. Interest-driven data visualization systems enable users to specify reports including data visualizations that enable the user to explore the raw data stored within the distributed computing platform 110 using reporting data generated by the interest-driven business intelligence server system 112. Reporting data is provided in a variety of forms, including, but not limited to, snowflake schemas and star schemas as appropriate to the requirements of specific applications in accordance with embodiments of the invention. In many embodiments, reporting data is any data that includes fields of data populated using data stored within the distributed computing platform 110.

Based on received reporting data requirements, the interest-driven business intelligence server system 112 automatically compiles one or more interest-driven data pipelines to create or update reporting data to satisfy the received reporting data requirements. The interest-driven business intelligence server system 112 is configured to compile one or more interest-driven data pipelines configured to create and push down jobs to the distributed computing platform 110 to create source data and then applying various filtering, aggregation, and/or alignment processes to the source data to produce reporting data to be transmitted to interest-driven data visualization systems.

The interest-driven business intelligence server system 112 and/or the interest-driven data visualization systems are configured to create segment data identifying groupings of data within the data stored on the system. In several embodiments, the interest-driven business intelligence server system 112 is configured to create segment data based on segment data metadata. The segment data metadata is commonly obtained from an interest-driven data visualization system, where the segment data metadata is defined as reporting data is explored via the interest-driven data visualization system. Based on the segment data metadata, the interest-driven business intelligence server system 112 can group pieces of data in order to create the corresponding segment data than can then be transmitted to an interest-driven data visualization system for exploration. The interest-driven business intelligence server system 112 can also gather several pieces of segment data together into composite segment data so that several pieces of segment data can be analyzed together. Similarly, an interest-driven data visualization system can create segment data and/or composite segment data based on the reporting data present in the interest-driven data visualization system. The segment data (metadata) can be utilized by the interest-driven business intelligence server system 112 and/or interest-driven data visualization system to dynamically generate updated segment data based on changes made to the data (e.g. the source data, aggregate data, event-oriented data, filtered data, and/or reporting data) stored on the system. In this way, segment data (metadata) can also act as a filter to automatically update reports utilizing the segment data based on changes within the data underlying the report.

In many embodiments, the interest-driven business intelligence server system 112 includes reporting data, source data, event-oriented data, and/or aggregate data that partially or fully satisfy the reporting data requirements. The interest-driven business intelligence server system 112 is configured to identify the relevant existing reporting data, aggregate data, event-oriented data, and/or source data and configure an interest-driven data pipeline to create jobs requesting reporting data minimizing the redundancy between the existing data and the new reporting data requirements. In a variety of embodiments, the interest-driven business intelligence server system 112 is configured to determine redundancies between the requested data and existing data using metadata describing the data available from the distributed computing platform 110. In a number of embodiments, the metadata further describes what form the data is available in, such as, but not limited to, aggregate data, filtered data, source data, reporting data, and event-oriented data. In several embodiments, the interest-driven business intelligence server system 112 obtains a plurality of reporting data requirements and creates jobs using the interest-driven data pipeline to create source data containing data fulfilling the union of the plurality of reporting data requirements. In a variety of embodiments, the interest-driven business intelligence server system 112 is configured to identify redundant data requirements in one or more reporting data requirements and configure an interest-driven data pipeline to create jobs requesting source data fulfilling the redundant data requirements. In several embodiments, the interest-driven business intelligence server system 112 is configured to store aggregate data, event-oriented data, and/or reporting data in a data mart and utilize the stored data to identify the redundant data requirements. In a number of embodiments, the interest-driven business intelligence server system 112 is configured to identify when reporting data requirements request updated data for existing reporting data and/or source data and configure an interest-driven data pipeline to create jobs to retrieve an updated snapshot of the existing reporting data from the distributed computing platform 110.

In several embodiments, jobs pushed down to the distributed computing platform 110 by the interest-driven business intelligence server system 112 cannot be executed in a low-latency fashion. In many embodiments, the distributed computing platform 110 is configured to provide a partial set of source data fulfilling the pushed down job and the interest-driven business intelligence server system 112 is configured to create reporting data using the partial set of source data. As more source data is provided by the distributed computing platform 110, the interest-driven business intelligence server system 112 is configured to update the created reporting data based on the received source data. In a number of embodiments, the interest-driven business intelligence server system will continue to update the reporting data until a termination condition is reached. These termination conditions can include, but are not limited to, a certain volume of source data is received, the source data provided is no longer within a particular time frame, and an amount of time to provide the source data has elapsed. In a number of embodiments, a period and/or the amount of time to provide the source data is determined based on historical performance metadata describing the time previously measured in the retrieval of source data for similar reporting data requirements.

The interest-driven business intelligence server system 112 is configured to compile an interest-driven data pipeline to create jobs to be pushed down to the distributed computing platform 110 in order to retrieve data. In a variety of embodiments, the jobs created using the interest-driven data pipeline are tailored to the reporting data requirements. In many embodiments, the jobs created using the interest-driven data pipeline are customized to the hardware resources available on the distributed computing platform 110. In a number of embodiments, the jobs are configured to dynamically reallocate the resources available on the distributed computing platform 110 in order to best execute the jobs. In several embodiments, the jobs are created using performance metrics collected based on historical performance metadata describing the performance of previously executed jobs.

Although a specific architecture for an interest-driven business intelligence system in accordance with an embodiment of the invention is conceptually illustrated in FIG. 1, any of a variety of architectures configured to store large data sets and to automatically build interest-driven data pipelines based on reporting data requirements can also be utilized. It should be noted that any of the data described herein could be obtained from any system in any manner (i.e. via one or more application programming interfaces (APIs) or web services) and/or provided to any system in any manner as appropriate to the requirements of specific applications of embodiments of the invention. Systems and methods for interest-driven data visualization systems and segment data in accordance with embodiments of the invention are discussed in detail below.

### Interest-Driven Business Intelligence Server Systems

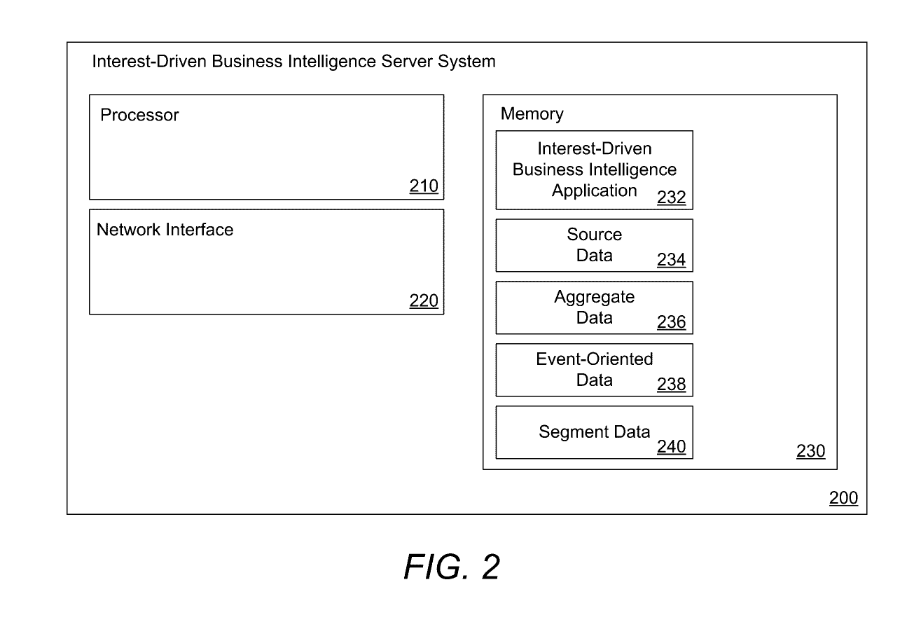

Interest-driven business intelligence server systems in accordance with embodiments of the invention are configured to create jobs to request source data based on received reporting data requirements and to create reporting data using the received source data. Segment data can then be created based on the source data and/or reporting data to facilitate the exploration of groups within the data. An interest-driven business intelligence server system in accordance with an embodiment of the invention is conceptually illustrated in FIG. 2. The interest-driven business intelligence server system 200 includes a processor 210 in communication with memory 230. The memory 230 is any form of storage configured to store a variety of data, including, but not limited to, an interest-driven business intelligence application 232, source data 234, aggregate data 236, event-oriented data 238, and segment data 240. The interest-driven business intelligence server system 200 also includes a network interface 220 configured to transmit and receive data over a network connection. In a number of embodiments, the network interface 220 is in communication with the processor 210 and/or the memory 230. In many embodiments, the interest-driven business intelligence application 232, source data 234, aggregate data 236, event-oriented data 238, and/or segment data 240 are stored using an external server system and received by the interest-driven business intelligence server system 200 using the network interface 220. External server systems in accordance with a variety of embodiments include, but are not limited to, distributed computing platforms and data marts.

The interest-driven business intelligence application 232 configures the processor 210 to perform a variety of interest-driven business intelligence process. In many embodiments, an interest-driven business intelligence process includes creating jobs using an interest-driven data pipeline to retrieve source data in response to reporting data requirements. The source data can then be utilized to generate aggregate data and/or event-oriented data as appropriate to the requirements of specific applications in accordance with embodiments of the invention. In a variety of embodiments, the created jobs are based on redundancies between reporting data requirements and existing source data 234, aggregate data 236, and/or event-oriented data 238. In a number of embodiments, the interest-driven business intelligence process includes updating reporting data based on incrementally received source data and/or updated source data. The interest-driven business intelligence process further includes generating segment data 240 by grouping portions of the source data 234, aggregate data 236, and/or event-oriented data 238 according to segment grouping data. The segment grouping data can identify one or more dimensions and/or facts within the source data 234, aggregate data 236, and/or event-oriented data 238. In particular, segment grouping data can identify binary segments (e.g. a dimension does or does not exist/have a particular value), multi-valued segments (e.g., dimensions having a value falling within one or more ranges), and quantitative-valued segments (e.g., number of pages clicked). These identified segments can occur across one or more dimensions (individually or in combination) within the source data, aggregate data, and/or event-oriented data. In a variety of embodiments, the segment data 240 includes segment data metadata describing the dimensions of the source data 234, aggregate data 236, and/or event-oriented data 238 that are to be included in the segment data 240. The segment data metadata can also describe any aggregations, filters, and/or alignments that are to be applied to the source data 234, aggregate data 236, and/or event-oriented data 238 in the creation of segment data 240. Pieces of segment data 240 can also be combined together to form composite segment data describing the data associated with multiple groupings within the data. In many embodiments, the segment data 240 is transmitted to interest-driven data visualization systems.

Although a specific architecture for an interest-driven business intelligence server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. Systems and methods for interest-driven data visualization systems configured to utilize segment data in accordance with embodiments of the invention are discussed below.

### Interest-Driven Data Visualization Systems

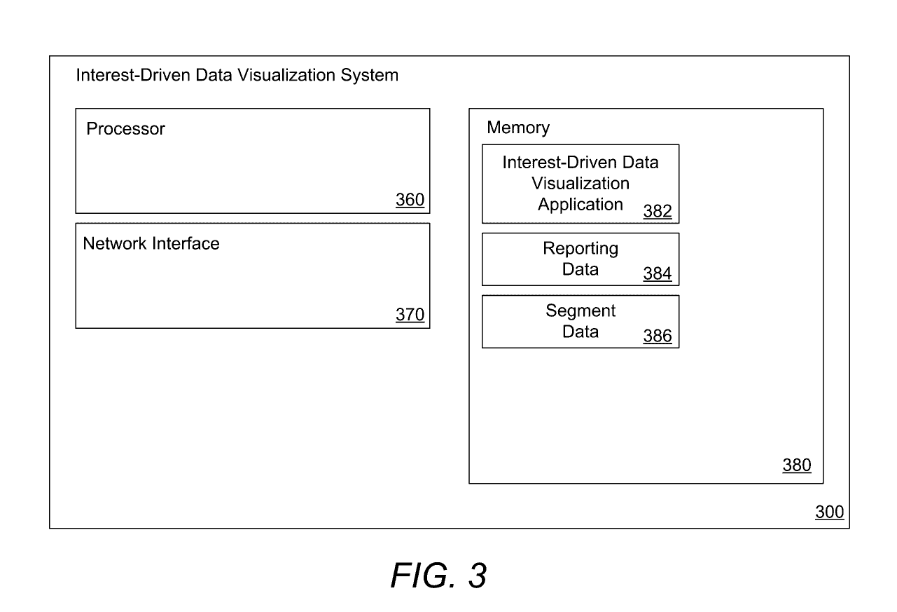

Interest-driven data visualizations systems in accordance with embodiments of the invention are configured to allow the exploration of reporting data. Based on the facts and dimensions within the reporting data, segment data can be defined. The segment data can then be utilized to explore the data associated with one or more groupings of data within the reporting data. An interest-driven data visualization system in accordance with an embodiment of the invention is conceptually illustrated in FIG. 3. The interest-driven data visualization system 300 includes a processor 360 in communication with memory 380. The memory 380 is any form of storage configured to store a variety of data, including, but not limited to, an interest-driven data visualization application 382, reporting data 384, and segment data 386. The interest-driven data visualization system 350 also includes a network interface 370 configured to transmit and receive data over a network connection. In a number of embodiments, the network interface 370 is in communication with the processor 360 and/or the memory 380. In many embodiments, the interest-driven data visualization application 382, reporting data 384, and segment data 386 are stored using an external server system and received by the interest-driven business data visualization system 300 using the network interface 370. External server systems in accordance with a variety of embodiments include, but are not limited to, interest-driven business intelligence server systems, distributed computing platforms, and data marts.

The interest-driven data visualization application 382 configures the processor 360 to perform an interest-driven data visualization process. The data visualization process includes exploring reporting data 384. Additionally, the data visualization process includes defining segment data metadata based on dimensions and/or facts within the reporting data 384. The segment data metadata can be utilized along with segment grouping data to create segment data 386 based on the reporting data 384. The segment data 386 can be explored as part of the interest-driven data visualization process to create reports facilitating the exploration of the reporting data 284 by analyzing groupings of data within the reporting data 384. Multiple pieces of segment data can be combined together into composite segment data to provide for the comparative exploration of multiple pieces of segment data. In a variety of embodiments, the segment data 386 is obtained from an interest-driven business intelligence server system based on the segment data metadata and/or the grouping data. In many embodiments, the interest-driven data visualization process further includes dynamically creating and/or updating segment data 386 based on the segment data metadata and/or grouping data as reporting data 384 is received and/or updated.

Although a specific architecture for an interest-driven data visualization system in accordance with an embodiment of the invention is conceptually illustrated in FIG. 3, any of a variety of architectures, including those that store data or applications on disk or some other form of storage and are loaded into memory at runtime, can also be utilized. Interfaces and processes for generating and exploring segment data as well as storing and using telemetry data in accordance with embodiments of the invention are discussed further below.

### Snapshot Isolation in Interest-Driven Data Sharing Server Systems

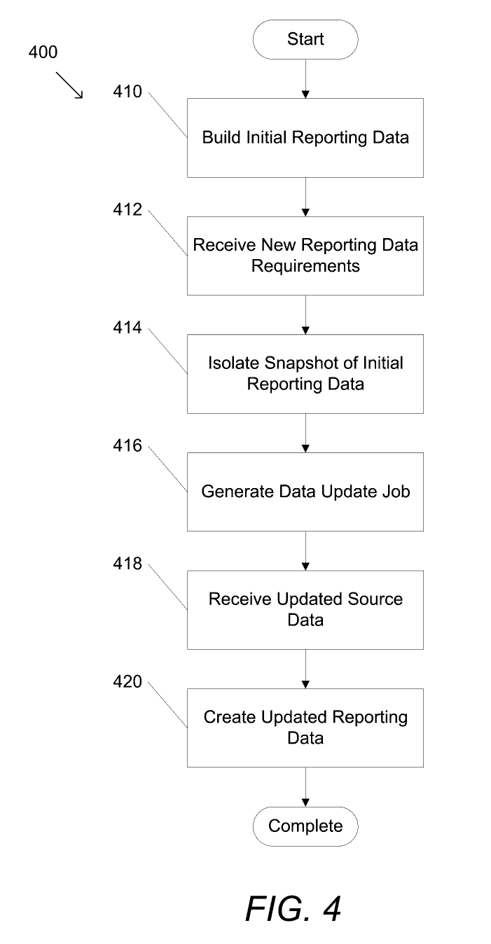

Typically, reporting data is generated by interest-driven data sharing server systems with respect to raw data available at a particular point in time. In many cases, analysts later create reports reflecting an updated view of the previously generated reporting data without disrupting the previously created reporting data. Interest-driven data sharing server systems are configured to create a snapshot isolating the previously created reporting data to preserve reports relying upon the previously created reporting data and generate jobs requesting updated reporting data to fulfill the new report requirements. A process for snapshot isolation in interest-driven data sharing server systems in accordance with an embodiment of the invention is illustrated in FIG. 4. The process 400 includes building (414) initial reporting data. New reporting data requirements are received (412). A snapshot of the initial reporting data is isolated (414). A data update job is generated (416). Updated source data is received (418). Updated reporting data is created (420).

In many embodiments, reporting data requirements are received (410) from an interest-driven data visualization system. In several embodiments, the received (410) reporting data requirements are based upon metadata describing raw data stored in an interest-driven business intelligence system. In several embodiments, isolating (414) a snapshot of the initial reporting data utilizes the received (412) new reporting data requirements. In a variety of embodiments, determining when a snapshot of the initial reporting data should be isolated (414) utilizes metadata describing updated raw data available from an interest-driven business intelligence system. In several embodiments, the snapshot is isolated (414) before the data update job is generated (416) and/or the updated source data is received (418). In many embodiments, the snapshot is isolated (414) after the data update job is generated (416) and/or the updated source data is received (418).

In a number of embodiments, the data update job is generated (416) using an interest-driven data pipeline. In many embodiments, the generated (416) data update job is based upon metadata describing raw data available from an interest-driven business intelligence system. In a variety of embodiments, the generated (416) data update job is configured to retrieve only the data that has been updated since the time that the initial reporting data was built (410); additional data can be retrieved along with the updated data as appropriate to specific requirements of specific embodiments of the invention. The time the initial reporting data was built (410) can be determined in a number of ways in accordance with embodiments of the invention, including, but not limited to, metadata associated with the initial reporting data, files storing the initial reporting data, the directory structure of the files storing the initial reporting data, and/or metadata associated with the files. Metadata associated with a file in accordance with many embodiments of the invention includes, but is not limited to, the creation date of the file, and the last modified date of the file. In a variety of embodiments, the generated (416) data update job is configured to retrieve data from a plurality of data sources associated with an interest-driven business intelligence system.

In several embodiments, the updated source data is received (418) from an interest-driven business intelligence system. In many embodiments, the received (418) updated source data includes a source data schema defining the dimensions and facts of the received (418) updated source data. In a number of embodiments, the received (418) updated source data includes metadata describing the data source providing the updated source data. In many embodiments, creating (420) the updated reporting data includes combining the source data schema for the updated source data with the reporting data schema for the initial reporting data. In a variety of embodiments, building (420) reporting data includes combining files associated with the existing reporting data and/or existing source data with the retrieved (418) source data. In several embodiments, creating (420) the updated reporting data includes logically eliminating redundant data between the initial reporting data and the updated source data.

Although a specific process for snapshot isolation in interest-driven data sharing server systems is illustrated in FIG. 4, any of a variety of processes can be utilized in accordance with embodiments of the invention. Processes for iterative reporting data generation in accordance with embodiments of the invention are discussed further below.

### Iterative Reporting Data Generation in Interest-Driven Data Sharing Server Systems

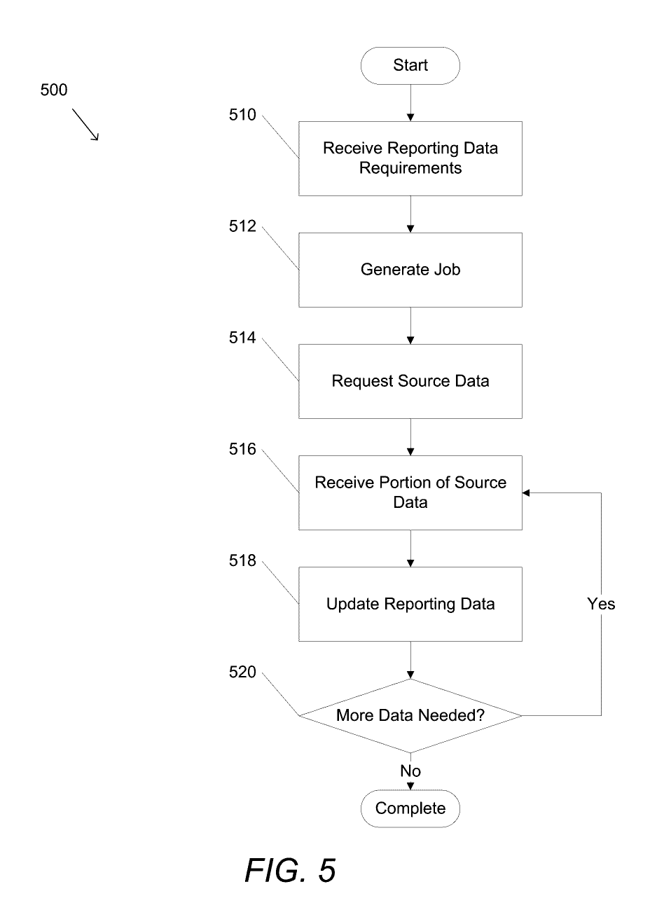

Interest-driven data sharing server systems are configured to create reporting data using source data received from an interest-driven business intelligence system. Interest-driven data sharing server systems create jobs to be pushed down to interest-driven business intelligence systems in order to create and retrieve source data that can be used to generate desired reports. However, the interest-driven business intelligence system providing the source data may not be able to execute the job in a low-latency fashion in all cases. In order to provide reporting data in a timely fashion, interest-driven data sharing server systems are configured to incrementally retrieve source data and create reporting data in an iterative fashion utilizing the incrementally received source data. A process for iterative reporting data generation in accordance with an embodiment of the invention is illustrated in FIG. 5. The process 500 includes receiving (510) reporting data requirements. A job is generated (512). Source data is requested (514). A portion of the source data is received (516). Reporting data is updated (518). If additional source data is needed (520), another portion of the source data is received (516). If no more data is needed (520), the process completes.

In many embodiments, reporting data requirements are received (510) from an interest-driven data visualization system. In several embodiments, the received (510) reporting data requirements are based upon metadata describing raw data stored in an interest-driven business intelligence system. In a number of embodiments, the job is generated (512) using an interest-driven data pipeline. In many embodiments, the generated (512) job is based upon metadata describing raw data available from an interest-driven business intelligence system. In a variety of embodiments, the generated (512) job retrieves only the source data that has not been previously received (516). The source data that has been previously received (516) can be determined in a number of ways in accordance with embodiments of the invention, including, but not limited to, metadata associated with the source data, files storing the source data, the directory structure of the files storing the source data, and/or metadata associated with the files. Metadata associated with a file in accordance with many embodiments of the invention includes, but is not limited to, the creation date of the file and the last modified date of the file.

Typically, source data is requested (514) from an interest-driven business intelligence system. Source data can be requested (514) from a variety of other data sources in accordance with the requirements of a particular embodiment of the invention. A received (516) portion of source data can be any variety of portions of source data in accordance with many embodiments of the invention. Portions of source data can be determined according to a variety of criteria including, but not limited to, the time span of the portion of source data, the time required to receive (516) the portion of source data, the size of the portion of source data received (516), requests for additional portions of source data, and the availability of resources on the business intelligence system providing the source data. In accordance with a number of embodiments, the process can determine that an adequate amount of source data is included in the portion data. The determination can be based upon the filtering and data transformations used to obtain the source data to ensure that the same amount of data is included in the portion data as was included in the original source data. A number of processes can be utilized to update (518) the reporting data using the received (516) portion of source data. These processes include, but are not limited to, those described above with respect to FIG. 3 and FIG. 5. Many conditions can be utilized to determine if more data is needed (520) including, but not limited to, those described above with respect to receiving (516) portions of source data. In many embodiments, as portions of source data are received, the estimate of the time and/or space required to receive the remaining portions of source data is updated.

Although a specific process for iterative reporting data generation using interest-driven data sharing server systems is described above with respect to FIG. 5, any of a variety of processes can be utilized in accordance with embodiments of the invention. Processes for sharing reporting data between interest-driven business intelligence systems using interest-driven data sharing server systems in accordance with embodiments of the invention are discussed below.

### Defining Segment Data

Interest-driven data visualization systems provide a variety of interfaces for exploring data obtained from interest-driven business intelligence server systems. During the exploration of data, users can identify particular features within the data can contain interesting details of the data. By grouping these features together and analyzing the grouped features, additional insights into the data can be identified. In accordance with some embodiments, segment data can be generated from reporting data to analyze specific information in the reporting data.

Segment data can be generated based identified dimensions and facts within the reporting data being explored. The identified dimensions and facts are utilized to create segment grouping data that is applied to the reporting data being explored to generate segment data. The segment grouping data can be included in segment data metadata describing the properties of the segment data. The segment data metadata is stored using the interest-driven data visualization system and/or an interest-driven business intelligence server system and can be reused in later explorations of the reporting data. Each piece of segment data represents the data associated with a grouping of data within the reporting data. The pieces of segment data can be used to determine the comparative performance of the various groupings of data within the reporting data and can be comparatively analyzed to identify trends within the data across the groups.

### Creating Segment Data

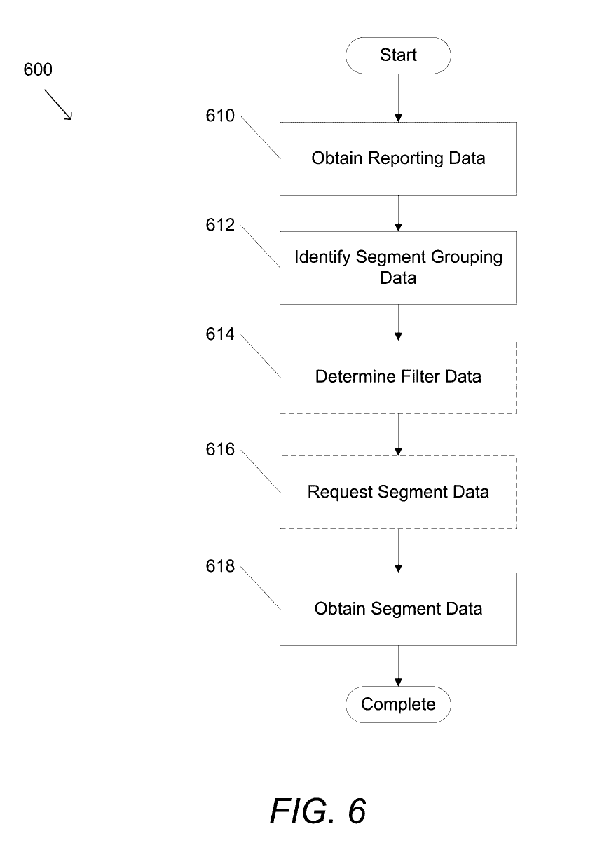

Segment data provides a grouping along one or more dimensions within a set of data. By analyzing a grouping of data, trends within the data associated with the group can be identified. For example, a particular class (e.g. group) of users of a web site can exhibit similar behaviors when interacting with a particular page within the web site that do not correspond to the usage patterns of the majority of the web site users. By identifying these groups of users, their interactions with the web sites can be explored and trends within their behavior can be identified. Interest-driven data visualizations in accordance with embodiments of the invention are configured to obtain the segment data metadata utilized to create segment data. A process for creating segment data in accordance with an embodiment of the invention is illustrated in FIG. 6. The process 600 includes obtaining (610) reporting data and identifying (612) segment grouping data. In several embodiments, filtering data is determined (614) and/or segment data is requested using segment grouping data (616). Segment data is obtained based upon the segment grouping data in the request (618).

In a variety of embodiments, reporting data is obtained (610) from interest-driven business intelligence server systems. In many embodiments, identifying (612) segment grouping data includes identifying at least one dimension and/or fact within the obtained (610) reporting data. Any reporting data, including aggregate reporting data and event-oriented reporting data, can be utilized as appropriate to the specific requirements of various embodiments of the invention. The segment grouping data can also be identified (612) based on aggregations and/or other values generated based on the dimensions and/or facts, either within the reporting data or externally defined, as appropriate to the requirements of specific applications in accordance with embodiments of the invention. In a number of embodiments, filtering data is utilized to include only pieces of data within the segment data having dimensions and/or facts corresponding to the filtering data. In this way, relevant data can be identified and included in the segment data based upon the filtering data. In a number of embodiments, the determined (614) filter data is included within segment data metadata. In several embodiments, requesting (616) segment data includes transmitting segment data metadata including the segment grouping data (and the filtering data if applicable) to an interest-driven business intelligence server system. In a variety of embodiments, segment data is obtained (618) from an interest-driven business intelligence server system. In many embodiments, segment data is obtained (618) by applying the identified (612) segment grouping data and/or the determined (614) filter data to reporting data present within an interest-driven data visualization system.

By way of example, the determined (614) filter data can include one or more pieces of user identification data. The filter data can then be utilized to request (616) segment data only including user identification data associated with the determined (614) filter data. Similarly, the determined (614) filter data can include time-based filtering criteria. The filtering process can include mapping the filter data to the requested data in order to account for differences between data sources providing the raw data utilized in the creation of the data used throughout the interest-driven business intelligence server system. Adjustments to data include, but are not limited to, accounting for timing differences between systems and tracking identification information across systems. Adjusting the data can be performed by shifting the data to a common format and/or by performing mappings of data to a common set of data. For example, with respect to time-based data, data acquired from multiple sources can all be converted to Coordinated Universal Time (UTC) in order to account for different time bases across systems. Similarly, time-based data can be adjusted based on threshold values to account for timing differences between the system clocks of a variety of systems providing data. Additionally, with respect to identification-based data (e.g. user identification data), a variety of universal tracking information can be utilized to map identification-based data to the universal tracking information in order to account for differences between the identification-based data across the systems providing the data. In this way, users can be identified across disparate systems (and disparate portions within a system) in order to provide the ability to analyze the user's data across the systems. It should be noted, however, that any filtering process could be utilized as appropriate to the requirements of specific applications in accordance with embodiments of the invention.

Although a specific process for creating segment data is described above with respect to FIG. 6, any of a variety of processes, including those that create segment data based on dimensions and/or facts not within the reporting data, can be utilized in accordance with embodiments of the invention. Processes for creating composite segment data in accordance with embodiments of the invention are discussed further below.

### Creating Composite Segment Data

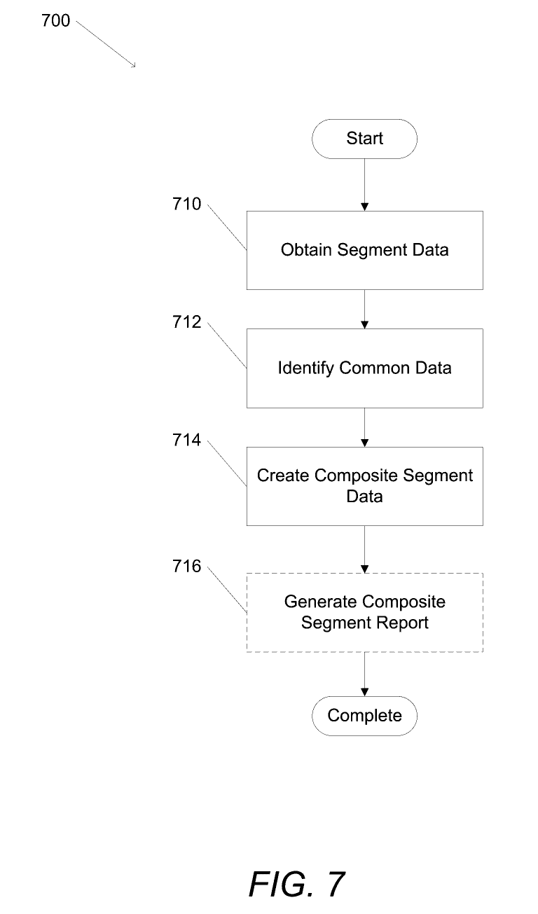

During the exploration of data, it is often useful to compare a variety of groupings of data to compare trends across the groups of data. Composite segment data can be created that associate multiple groupings of data. The groupings of data can be created concomitant with the composite segment data; however, composite segment data is commonly created based on previously created segment data. In a variety of embodiments, the exploration of data includes presenting the union of a number of groups of data as a way to compare segment data across the union of the groups of data. Returning to the example above with respect to FIG. 6, multiple pieces of segment data (each identifying a grouping of users within the web site) can be grouped together to comparatively explore the interactions each group of users has with the web site. Interest-driven data visualization systems in accordance with embodiments of the invention can be configured to associate groupings of segment data and provide an interface for exploring the groupings of data. A process for creating composite segment data in accordance with an embodiment of the invention is illustrated in FIG. 7. The process 700 includes obtaining (710) segment data and identifying (712) common data. Composite segment data is created (714) and, in several embodiments, composite segment reports are generated (716).

In a number of embodiments, segment data is obtained (710) utilizing processes similar to those described above. In several embodiments, common data is identified (712) based on the dimensions and/or facts contained within the obtained (710) segment data. In a variety of embodiments, composite segment data is created (714) based on the obtained (710) pieces of segment data that have the identified (712) common data in common. In many embodiments, the created (714) composite segment data contains pieces of segment data that have facts within a threshold value of the identified (712) common data. The threshold values can be pre-determined and/or determined dynamically based on the pieces of segment data as appropriate to the requirements of specific applications in accordance with embodiments of the invention. In a number of embodiments, a composite segment report is generated (716) based on the created (714) composite segment data utilizing techniques similar to those described above.

A specific process for creating composite segment data is described above with respect to FIG. 7; however, any of a variety of processes, including those that create composite segment data utilizing other data in addition to segment data, can be utilized in accordance with embodiments of the invention. Techniques for generating segment data in accordance with embodiments of the invention are described below.

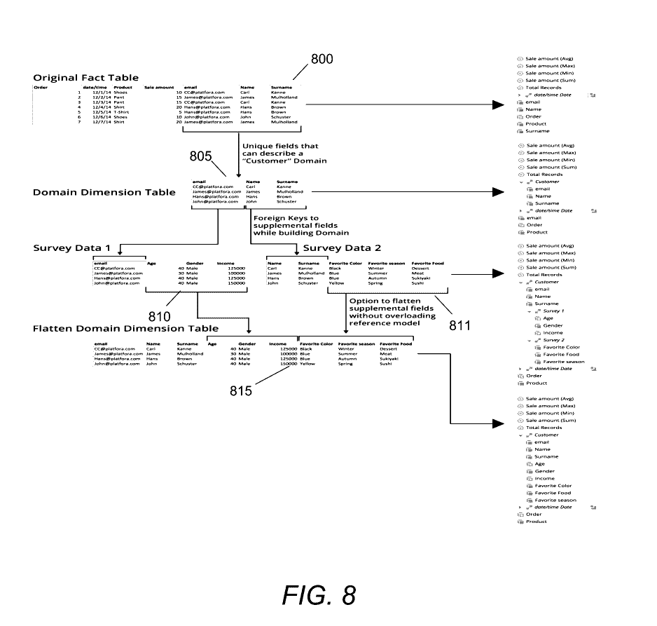

An example of the creation of composite segment data in accordance with an embodiment of the invention is conceptually shown in the data map illustrated in FIG. 8. Segment data 805 is a group of segment data that includes customer information. Segment data 810 and 811 are groups of segment data that include survey information about each particular customer. The segment data 805, 810, 811 can be selected using selection buttons 820, 830, and 840 to be combined in composite segment data that includes the customer information from data segment 805 as well as information associated with each customer from segment data 810 and 811.

With reference to FIG. 7, the above process can be performed in the following manner in accordance with some embodiments of the invention. The individual the segment data 805, 810, and 811 are generated or obtained (710) from the reporting data 800 using a process such as the process described above with respect to FIG. 6.

The segments of data 805, 810, and 811 are searched to identify common data dimensions (712). The common data dimensions of a customer email is found between segment data 805 and segment data 810; and common data dimensions of a name and surname is found between segment data 805 and segment data 811. Composite segment data is then generated using the common data dimensions to combine the data from the three data segments (714). The composite segment data can then be stored or provided for further analysis (716). In accordance with some other embodiments of the invention, another process for generating composite data can be performed in which the filters generating a portion of segment data are selected such that the filters output common data in a single dimension regardless of the original pieces of data in the dataset.

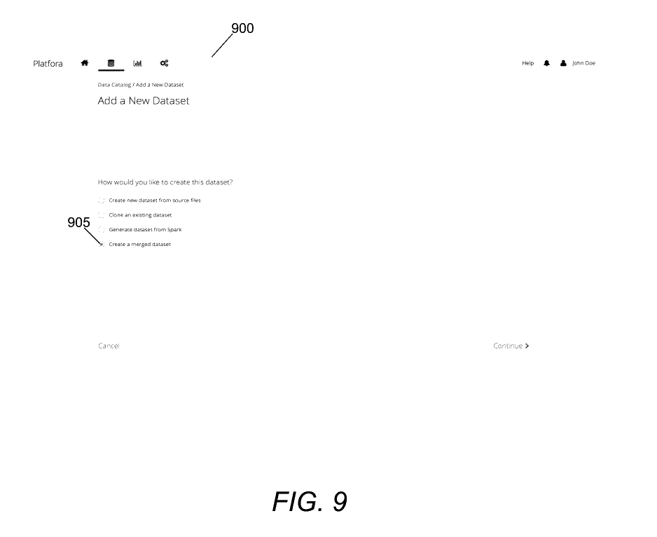

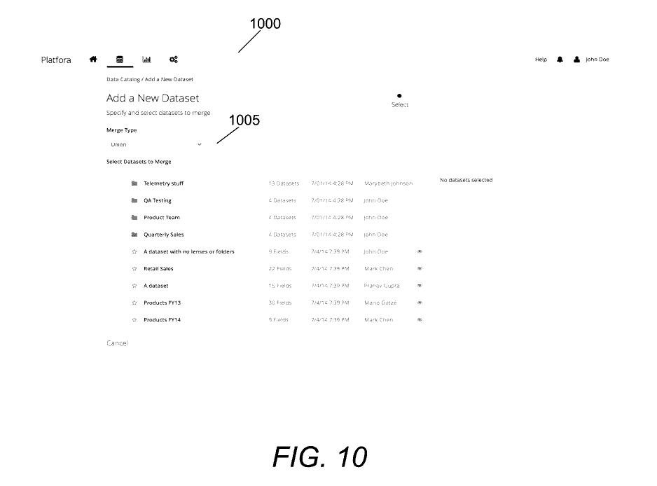

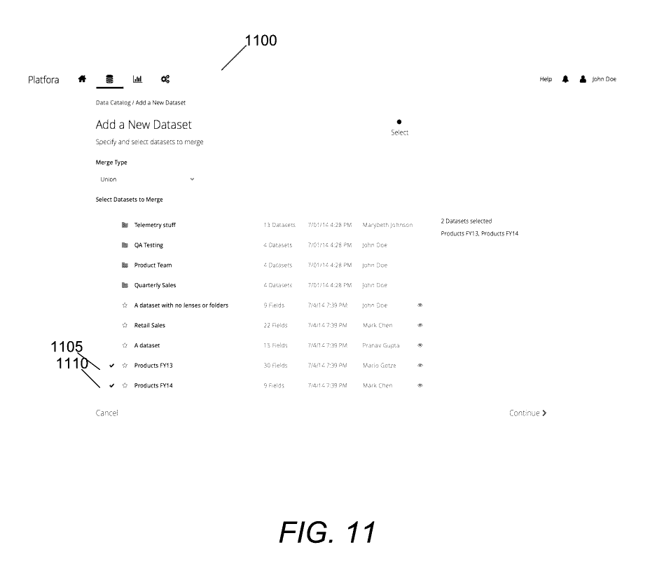

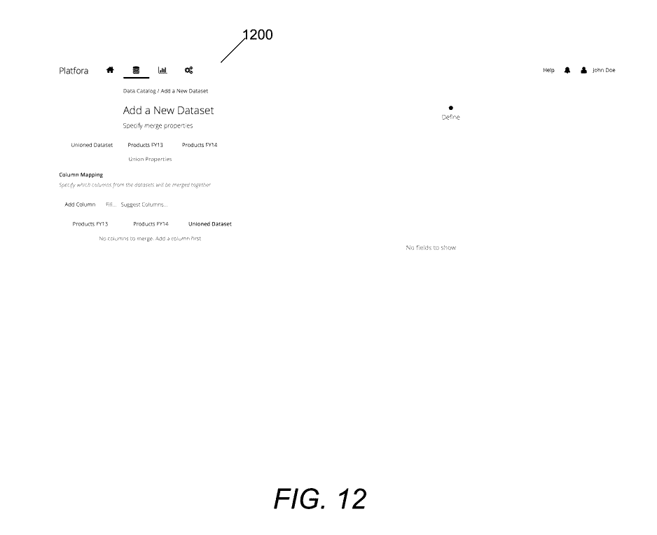

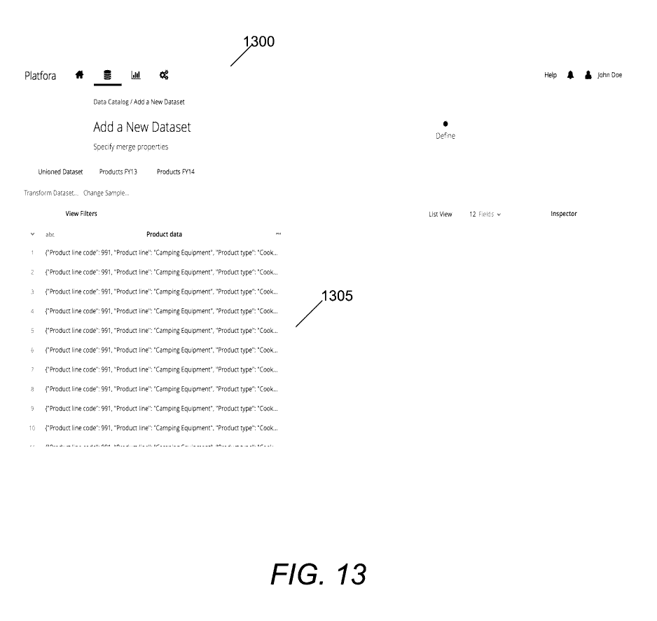

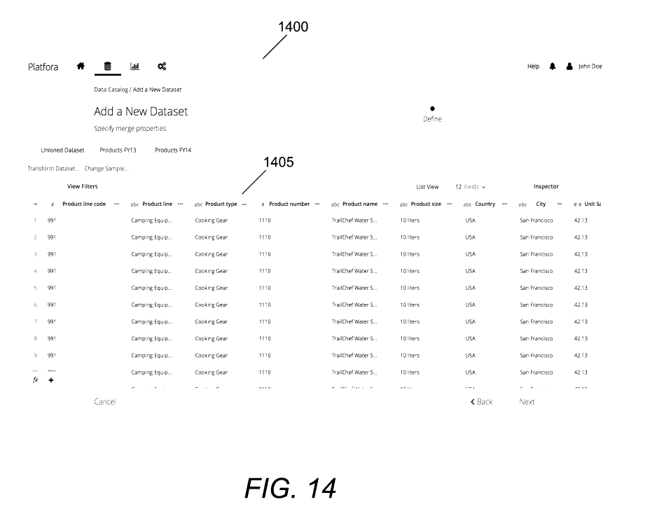

A second example of composite segment data generated from segment data is composite segment data that is a union of segment data from two groups. Interfaces for a process of generating composite segment data that is a union of two groups of segment data in accordance with an embodiment of this invention are illustrated in FIGS. 9-14. In FIG. 9, the interface 900 allows a user to select a type of dataset to create. This is a selection of the type of segment data that the user wants to create from store segment data. In interface 1000 shown in FIG. 10, a selection 1015 is input that indicates the type of merge of the segment data to be performed is a union of the selected segment data. In the interface 1100 shown in FIG. 11, datasets or segment data 1105 and 1110 have been selected to be merged to form the new dataset of composite segment data. An interface 1200 that is used to specify the merge properties for the merge is shown in FIG. 12. To aid in the specifying of merge properties the filter data 1305 of the one or more of the groups of segment data can be shown in an interface such as interface 1300 shown in FIG. 13. An alternative view of the filters form one or more of the datasets can be shown as is shown in interface 1400 in FIG. 14 in which the filters are shown as columns and the segment data is presented.

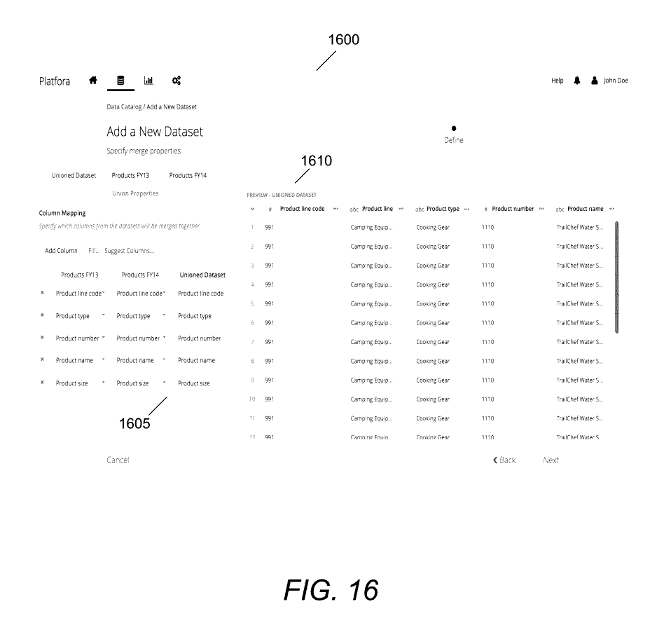

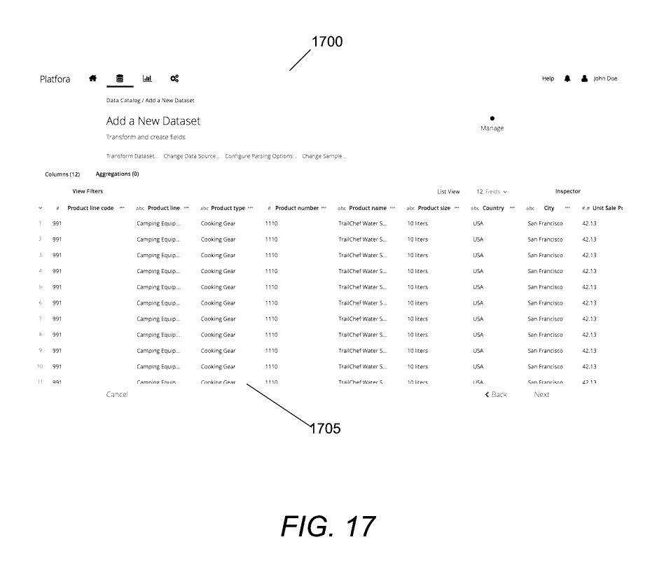

An interface 1500 can then be provided to show the application of filters to order the data in the dataset of composite segment data. In accordance with some embodiments, the system can provide suggestions of filters 1605 based upon the segment data being merged as shown in interface 1600 shown in FIG. 16. The composite segment data 1705 forming the new data set is shown using the selected filters in interface 1700 shown in FIG. 17. This composite segment data can then be saved for use in later analysis of the data.

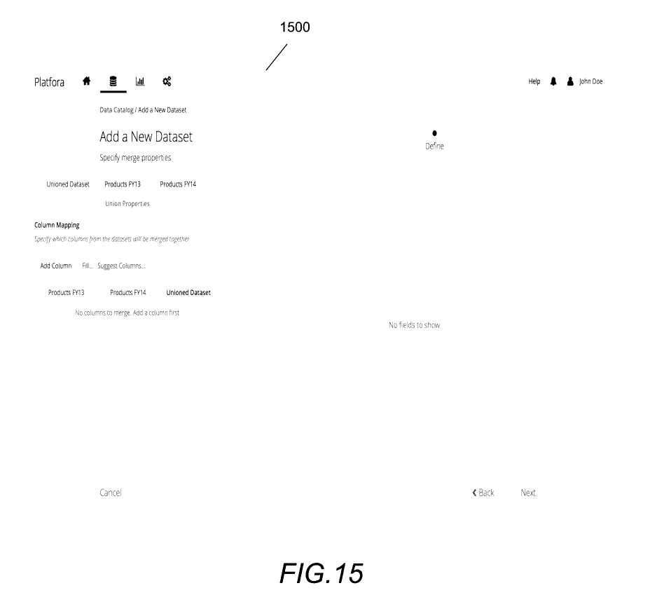

Referring back to FIG. 7, the creating a new merged dataset of composite segment from to datasets of segment data shown in FIGS. 9-17 can be performed in the following manner in accordance with some embodiments. The segment data 1105 and 1110 selected in interface 1100 are obtained (710). The common data is identified as shown in that the common filters are input or suggested in interfaces 1500 and 1600 (712). The new dataset that is composite segment data 1705 that is union of segment data 1105 and 1110 is created (714) and can presented to the user or stored for future use (716).

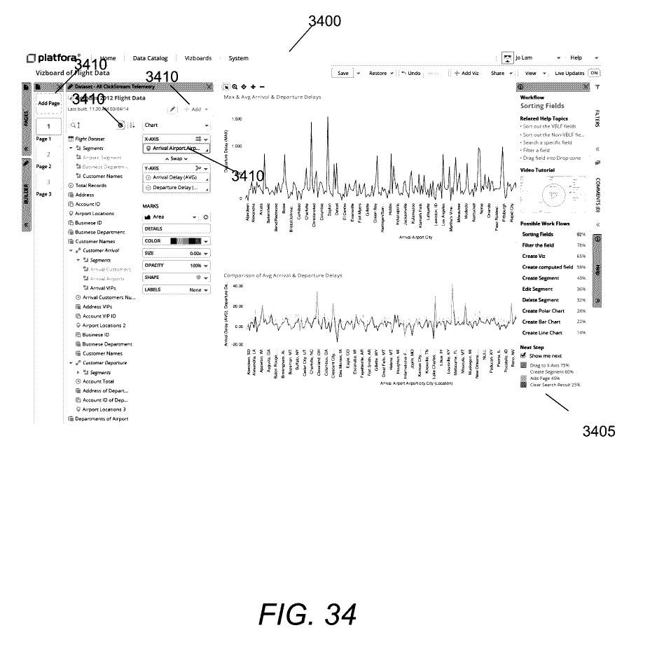

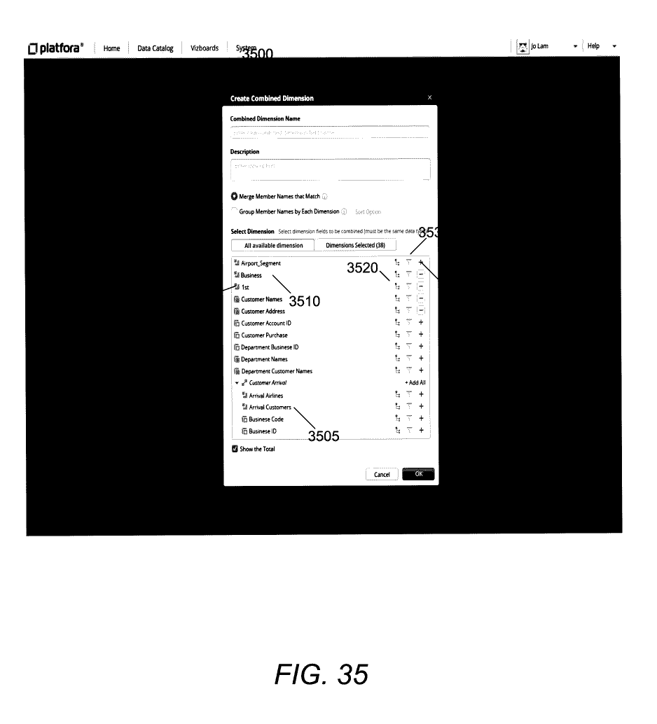

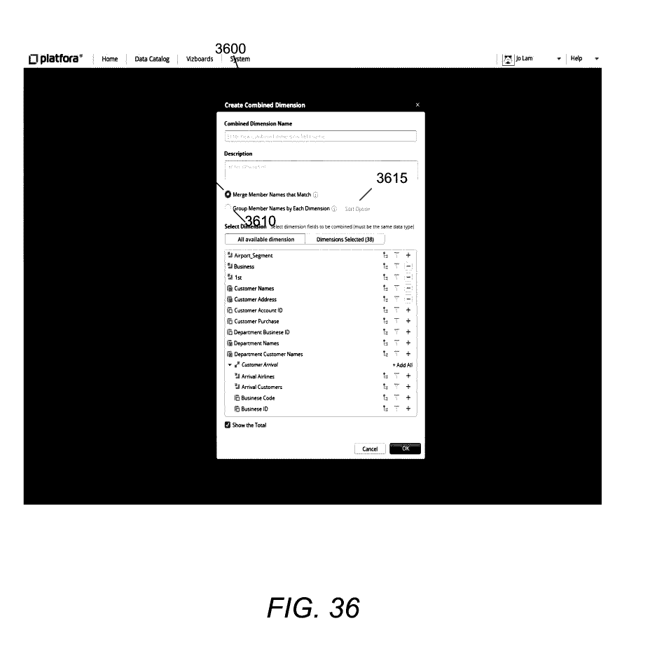

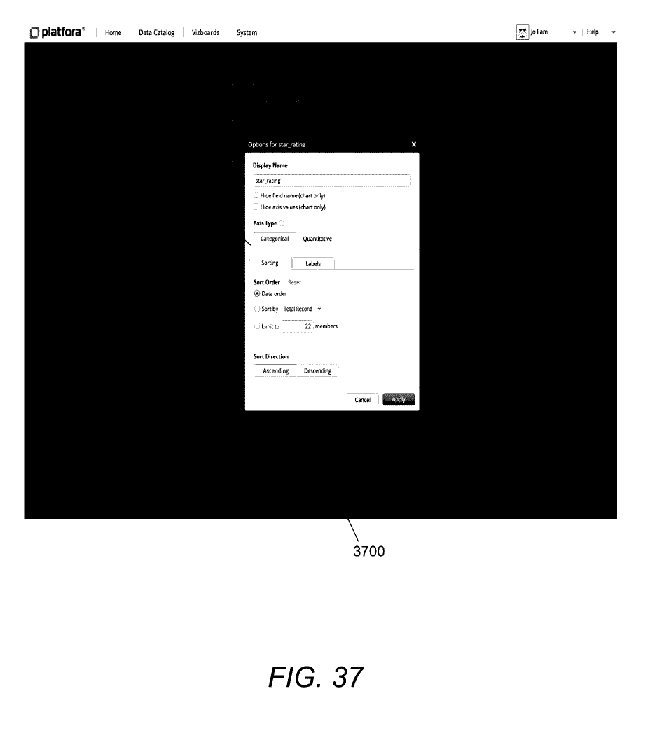

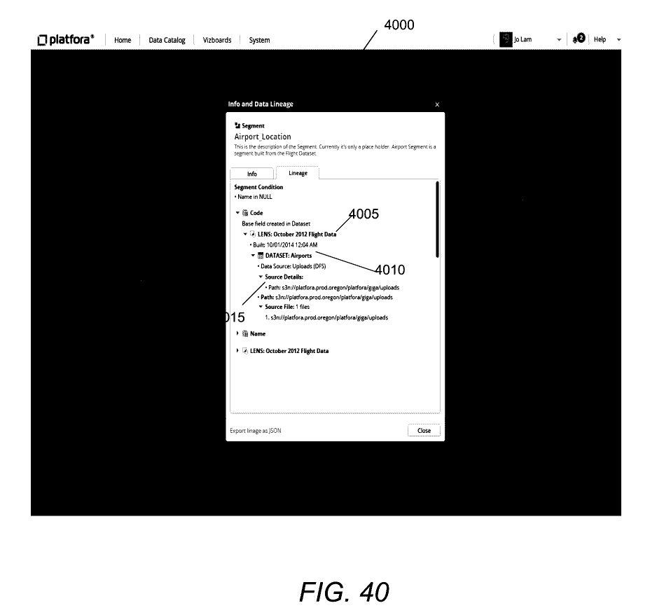

In accordance with some embodiments of the invention, another process for generating composite data can be performed by selecting the proper filters to have common dimensions in the datasets or data segments align in a new data segment being created. An example of interfaces that provide composite data segments using filters on one or more sets of data or data segments in accordance with embodiments of the invention is shown in FIGS. 35-40. Interface 3500 shown in FIG. 34 is an interface for generating a segment of data from other segments of data that have a common data dimension. In interface 3500, segments of data 3505, 3510, and 3511 are selected using button display 3540. Interface 3600 shown in FIG. 36 shows the options 3605, 3610, and 3615 that can be selected for sorting the resulting segment of data. In the illustrated embodiments, the options are merging member names that match 3605, group member names by each dimension 3610, and a sort option 3615 that provides a secondary window interface for entering a customized sorting option. Interface 3700 shown in FIG. 37 is a window interface provided when sort option 3615 is selected and provides sorting and labeling options 3705 for the user to use to order the data.

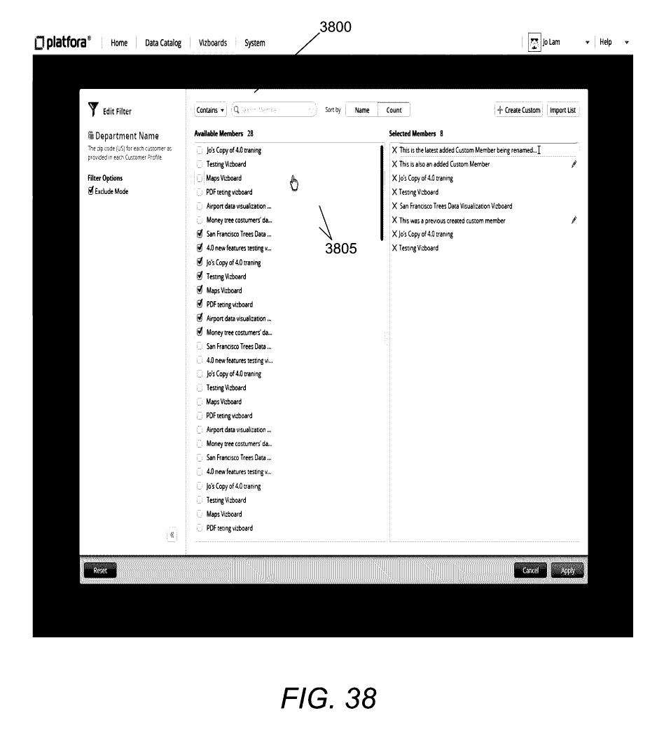

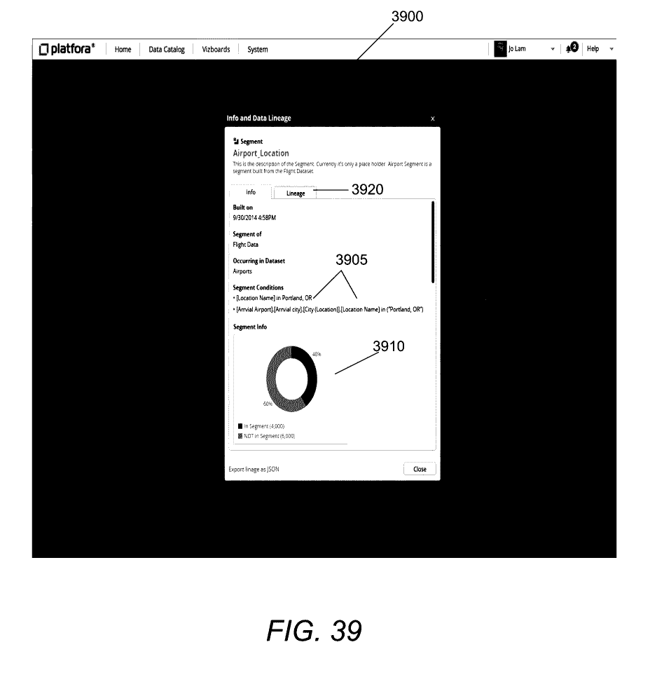

Interface 3800 shown in FIG. 38 shows the application of filters to data in the composite segment data set where bars 3805 show the amount of data in the composite segment data set that is likely to be captured by the filter. In accordance with some embodiments, interface 3800 can also provide suggestions as to which filters to application. Interface 3900 in FIG. 39 shows information about the composite segment data. The information can include conditions 3905 of the composite segment data that can include the dimensions of the data and/or filters applied to the data to generate the data in the composite segment data set. Furthermore, the information can include how much of the source data is captured in the composite segment data as shown by graphic 3910. Interface 4000 shows the lineage information for the composite segment data when a lineage tab from interface 3900 is selected. The interface 4000 includes data lens information 4005 about the lens used to obtain the source data, dataset information 4010 indicating the dataset used as source information and particular details about source data 4015.

Although specific processes for generating and manipulating data are described above with respect to FIGS. 35-40, any of a variety of processes and interfaces, including those that generate reporting data utilizing processes other than those described above, can be utilized in accordance with embodiments of the invention. In particular, the processes and interfaces described above can be utilized by interest-driven data visualization systems to generate reporting data. Additionally, any of the various processes described above can be performed in alternative sequences and/or in parallel (on different computing devices) in order to achieve similar results in a manner that is more appropriate to the requirements of a specific application.

### Generating Segment Data

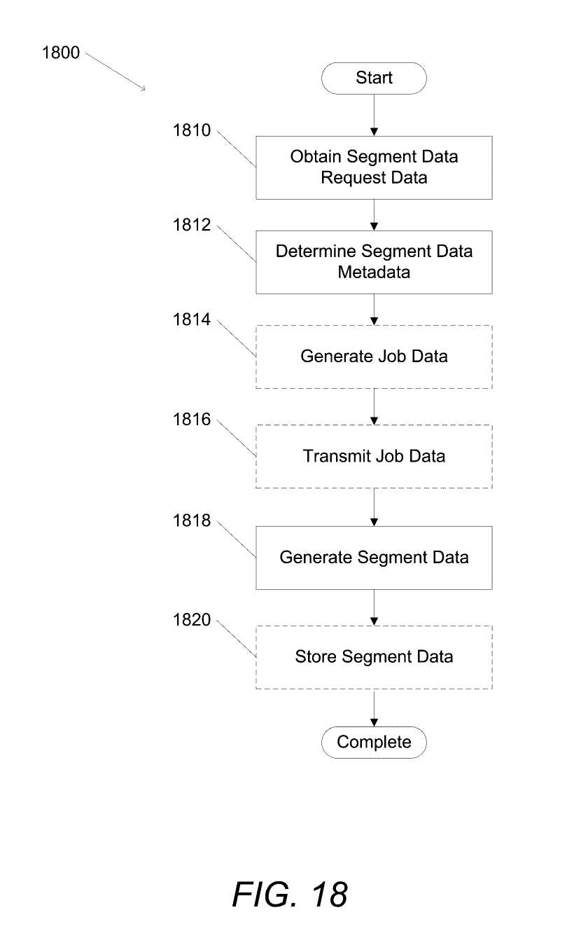

As described above, segment data provides a grouping of data. In several embodiments, segment data can be utilized to automatically filter a portion of data according to the segment data. Interest-driven business intelligence server systems in accordance with embodiments of the invention are configured to generate segment data. A process for generating segment data in accordance with an embodiment of the invention is illustrated in FIG. 18. The process 1800 includes obtaining (1810) segment data request data and determining (1812) segment data metadata. In several embodiments, job data is generated (1814) and/or job data is transmitted (1816). Segment data is generated (618) and, in a number of embodiments, segment data is stored (1820).

In a variety of embodiments, segment data request data is obtained (1810) from an interest-driven data visualization system. The segment data request data includes segment data metadata and/or segment grouping data identifying the dimensions and/or facts of the requested segment data. The segment data request can identify one or more pieces of segment data. In many embodiment, segment data metadata is determined (1812) based on the obtained (1810) segment data request data. In a number of embodiments, determining (1812) segment data metadata includes mapping the fact and/or dimensions defined in the segment data request data to facts and/or dimensions present in the source data stored in the interest-driven business intelligence server system. In several embodiments, the segment data request data includes facts and/or dimensions that are not present in the source data available. Job data is generated (1814) to obtain the facts and/or dimensions that are not present. In a number of embodiments, job data is generated (1814) to request updated source data corresponding to the determined (1812) segment data metadata. In many embodiments, the job data is transmitted (1816) to a distributed computing platform and additional and/or updated source data is obtained in response to the transmitted (1816) job. In a variety of embodiments, segment data is generated (1818) based on the determined (1812) segment data metadata and the source data present in the interest-driven business intelligence server system. In several embodiments, the generated (1818) segment data is stored (1820) so that the segment data can be provided later. In a number of embodiments, the determined (1812) segment data metadata is stored. In this way, the segment data metadata can be utilized to generate additional pieces of segment data at later time. For example, the segment data metadata can be used to generate additional segment data as the underlying source data changes over time.

Although a specific process for generating segment data is described above with respect to FIG. 18, any of a variety of processes, including those that store segment data using alternative techniques to those described above, can be utilized in accordance with embodiments of the invention. In particular, the processes described above can be utilized by interest-driven data visualization systems to generate segment data utilizing reporting data present within the interest-driven data visualization system. Processes for generating reporting data based on segment data in accordance with embodiments of the invention are discussed further below.

### Generating Reporting Data Using Segment Data

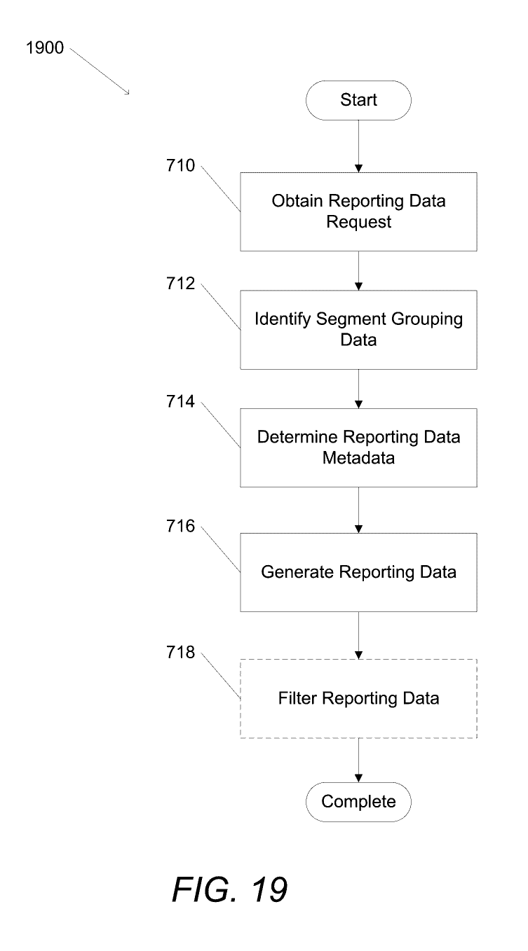

Once trends have been identified within one or more pieces of segment data, it is often useful to analyze reporting data generated based on the identified trends. In this way, the reporting data provides additional information regarding the identified trends. Interest-driven business intelligence server systems in accordance with embodiments of the invention are configured to generate reporting data based on segment data. A process for generating reporting data based on segment data in accordance with an embodiment of the invention is illustrated in FIG. 19. The process 1900 includes obtaining (1910) a reporting data request and identifying (1912) segment grouping data. Reporting data metadata is determined (1914) and reporting data is generated (1916). In a number of embodiments, reporting data is filtered (1918).

In many embodiments, the obtained (1910) reporting data request includes segment data metadata describing the facts and/or dimensions of (composite) segment data. In a variety of embodiments, segment grouping data is identified (1912) based on the segment data metadata. In several embodiments, segment grouping data is identified (1912) by mapping facts and/or dimensions identified in the obtained (1910) reporting data request to source data present in an interest-driven business intelligence server system. In a number of embodiments, reporting data metadata is determined (1914) based on the obtained (1910) reporting data request and/or the identified (1912) segment grouping data. In many embodiments, reporting data is generated (1916) based on the determined (1914) reporting data metadata and the source data.

Generating (1916) reporting data can also include obtaining additional source data from a distributed computing platform utilizing techniques similar to those described above as appropriate to the requirements of specific applications in accordance with embodiments of the invention. In a variety of embodiments, the reporting data is filtered (1918) according to the identified (1912) segment grouping data. In this way, the generated (1916) reporting data can be targeted toward the segment data identified in the obtained (1910) reporting data request. Filtering (1918) of the reporting data can occur before and/or after the reporting data is generated as appropriate to the requirements of specific applications in accordance with embodiments of the invention. Filtering (1918) can include selecting and/or grouping a portion of the reporting data based on the segment grouping data.

Specific processes for generating reporting data based on segment data are described above with respect to FIG. 19; however, any of a variety of processes, including those that generate reporting data utilizing processes other than those described above, can be utilized in accordance with embodiments of the invention. In particular, the processes described above can be utilized by interest-driven data visualization systems to generate reporting data based on segment data utilizing reporting data present within the interest-driven data visualization system. Additionally, any of the various processes described above can be performed in alternative sequences and/or in parallel (on different computing devices) in order to achieve similar results in a manner that is more appropriate to the requirements of a specific application.

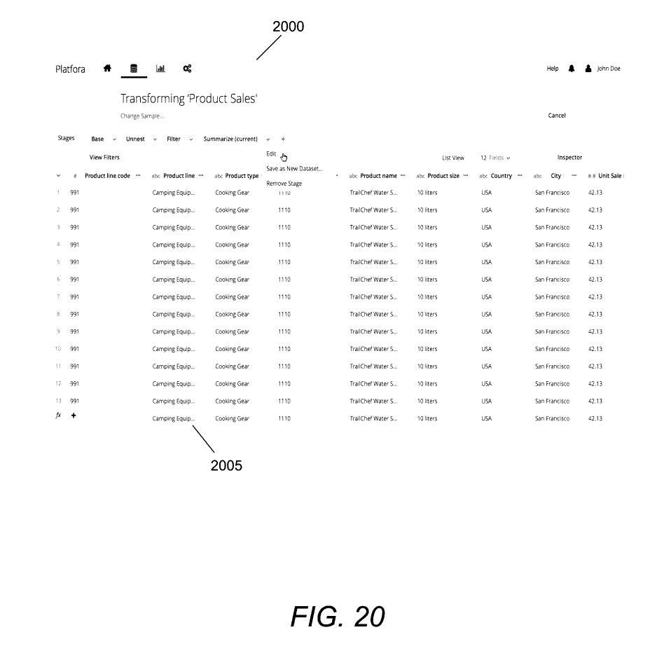

In accordance with some embodiments of the invention, segment data can be used to obtain samples of reporting data in order to modify the reporting data requirements to change the source data being obtained as source data for the reporting data. An example of interfaces provided by a visualization device to allow a user to use segment data to update the source data being obtained in accordance with invention in accordance with an embodiment of an invention is shown in FIGS. 20-23. A process such as the process described with regards to FIGS. 20-23 can be used association with a process such as the processes described with regards to FIGS. 5, 18, and 19 to modify the reporting data requirements, reporting data requests, and/or segment data request data in accordance with some embodiments of the invention.

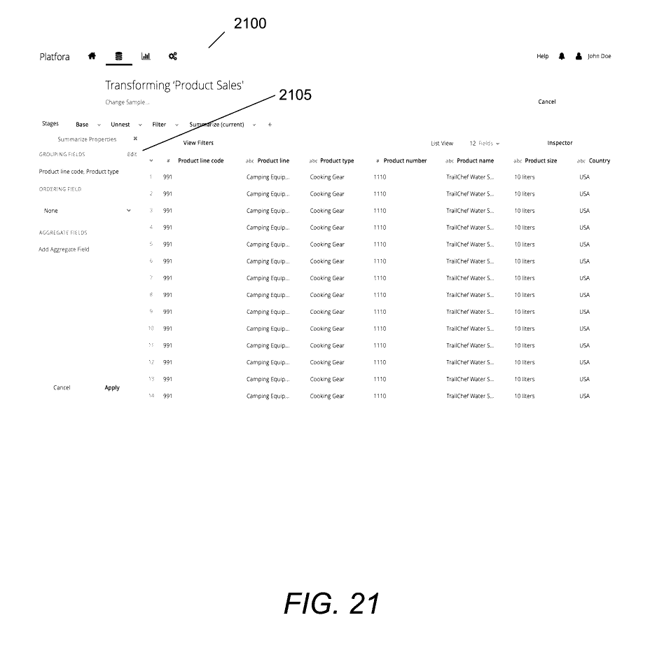

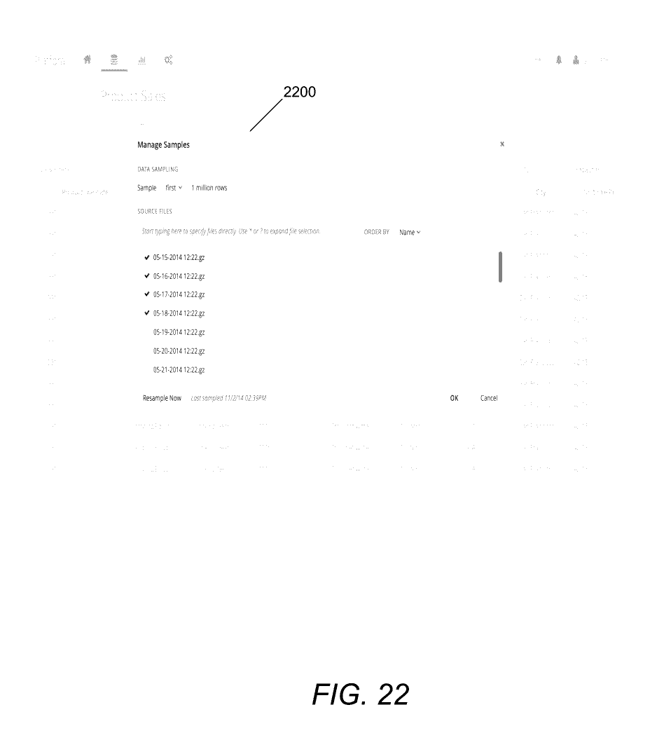

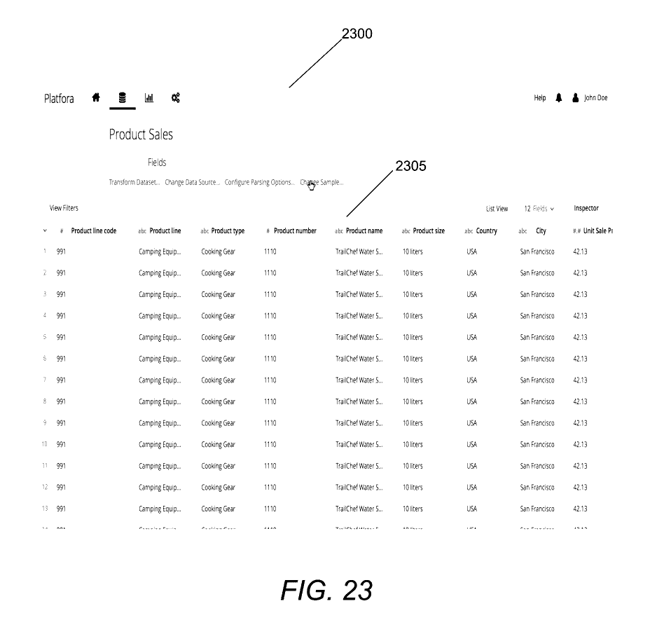

In FIG. 20, interface 2000 shows sample data 2005 of reporting data obtained based upon reporting data requirements. An interface, such as an interface 2100 shown in FIG. 21, can provide a box 2105 that allows a user to changes various parameters of a sample request. These parameters can include, but are not limited to, the grouping field (filters) used to group the reporting data and/or ordering field (filter) data used to order the reporting data and/or add aggregates that combine and/or transform individual pieces of reporting data. By way of example, one such transformation can include a conversion of temperatures from Fahrenheit to Celsius. An interface such as interface 2200 shown in FIG. 22 can be provided that allows a user to groups of segment data used to retrieve the sample data. In accordance with some embodiments, this can include segment data that only includes updated reporting data obtained during a particular time period or using some other property of the reporting data. An interface such as the interface 2300 shown in FIG. 23 can be provided. The interface 2300 shows the sample data generated in response to the sample data request. In some further embodiments, the sample data can be used to generate sample data metadata. The sample data request and the sample data metadata (in some embodiment) can be provided to an interest-drive business intelligence server system. The interest-drive business intelligence server system can use the sample data request and/or sample data metadata to modify the reporting data requirements, and reporting data request and/or sample data requests that are used to obtain subsequent source data in accordance with various embodiments.

A specific process for generating sample data is described above with respect to FIGS. 20-23; however, any of a variety of processes, including those that generate reporting data utilizing processes other than those described above, can be utilized to provide sample data in accordance with embodiments of the invention. In particular, the processes described above can be utilized by interest-driven data visualization systems to generate reporting data based on segment data utilizing reporting data present within the interest-driven data visualization system. Additionally, any of the various processes described above can be performed in alternative sequences and/or in parallel (on different computing devices) in order to achieve similar results in a manner that is more appropriate to the requirements of a specific application.

### Data Flows

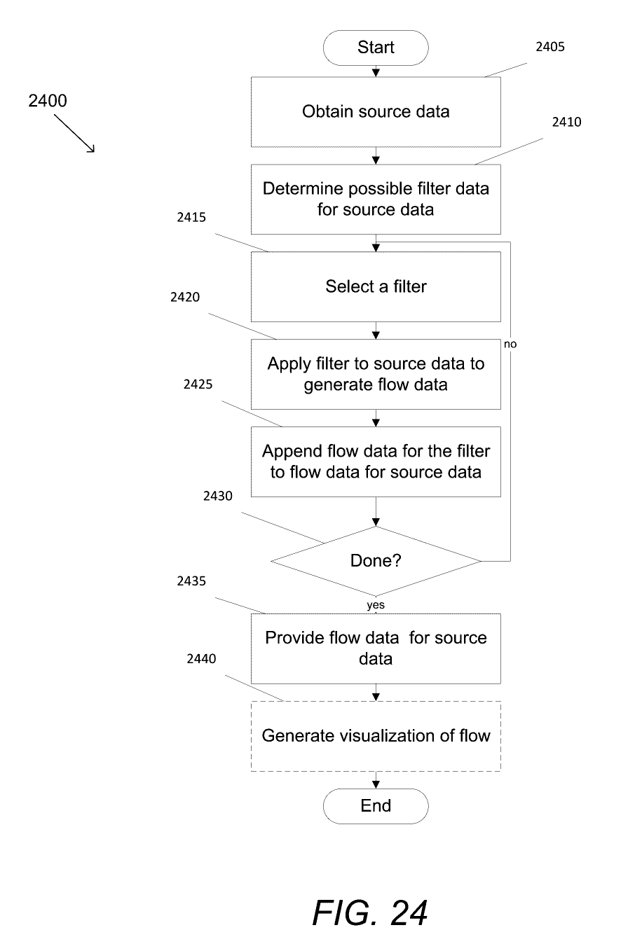

In order to analyze the data, analysts often need to obtain information about the associations between various pieces of data in the source data. One manner of describing the association between various pieces of the source data is flow data in accordance with some embodiments of the invention. The flow data describes the associations between various pieces of the source data based upon keys or filters that can be applied to the source data and/or the dimensions of the source data. The flow data can then be used to generate a flow visualization that shows the associations between pieces of the source data and changes to the associations based upon the application of various filters to the source data in accordance with a number of embodiments. A process for generating flow data and flow visualizations from the flow data performed by an interest-driven business intelligence server system and/or visualization system in accordance with embodiments of the invention is shown in FIG. 24.

In process 2400, source data can be obtained (2405). In accordance with various embodiments, the source data can be, but is not limited to, data retrieved from a computer platform, reporting data retrieved from the data retrieved, and or segment data derived from the reporting data. In some embodiments, the source data is a data set retrieved from a memory associated with an interest-driven business intelligence server system and/or visualization system. In accordance with other embodiments, the source data is data obtained from a computer platform system.

The process determines possible attributes from the source data. For purposes of this discussion, attributes can dimensions of the source data and/or filters that can be applied to one or more dimensions of the source data. The source data is searched and the attributes including dimensions and/or possible filter data are determined (2410). The possible filter data includes filters, sometimes referred to as keys that can be used to filter and/or organize the data. In accordance with some embodiments, the filters, keys, and/or dimensions of the source data can be determined from metadata for the source data. In accordance with some other embodiments, the dimensions and/or filters are received via an input from a user. In accordance with still other embodiments, the dimensions and/or filters are detected by analyzing the source data.

To generate the flow data, the process 2400 includes selecting an attribute from determined attributes (2415); applying the selected attribute to the source data to generate flow data for the attribute (2420); appending the generated flow data for the selected attribute to the stored flow data for the source data (2425); and repeating the process for each attributes in the set of determined attributes. In accordance with some embodiments, the application of the selected attribute is performed (2420) using the previously selected attributes. In many of these embodiments, the attributes are applied in the order selected. In some other embodiments, each selected attribute is individually applied to the source data. In accordance with some embodiments, the flow data is added to the metadata of the source data. In accordance with some embodiments, the flow data is stored separately from metadata and other data related to the source data.

After the flow data is generated, the flow data for the source data is provided to other applications and/or to a visualization system for use in analyzing the data (2435). In some embodiments, an optional step of generating flow visualization data from the flow data (2440) is performed by the interest-driven business intelligence system. In some other embodiments, the interest-driven business intelligence system provides the flow information to one or more visualization systems that generate the visualization data from the flow data.

Although a specific process for generating flow data for source data is described above with respect to FIG. 24, any of a variety of processes, including those that store segment data using alternative techniques to those described above, can be utilized in accordance with embodiments of the invention.

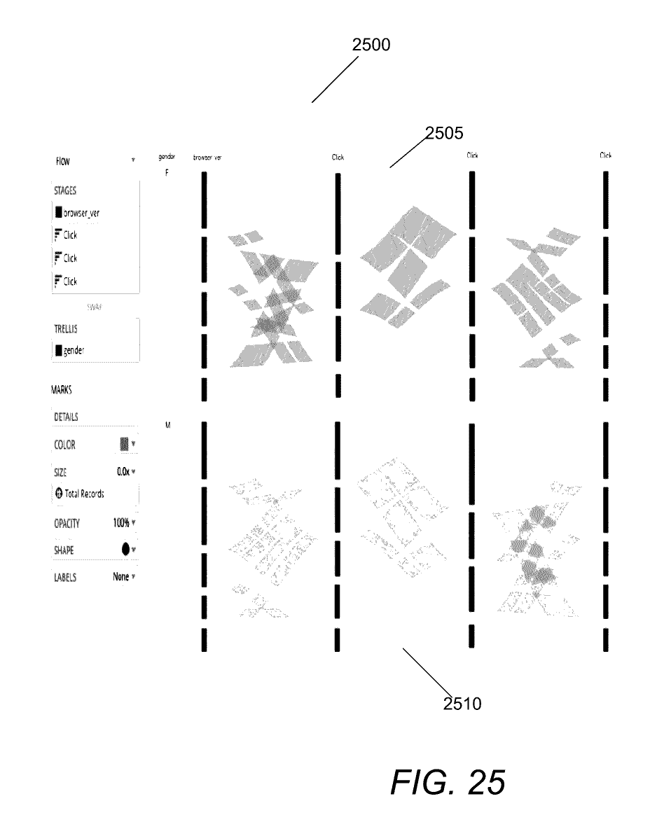

The flow data can be used to generate visualizations of the source data showing associations within the source data examples of interfaces showing the visualizations of flow data are shown in FIGS. 25-31. Interface 2500 shown in FIG. 25 includes a flow visualization 2505. The flow visualization 2505 has bars that act as columns parallel to the vertical axis show particular attributes applied to the source data and individual attributes within the filters separated by spaces. The lines that run along the vertical axis show the relationship of the data between the attributes. Furthermore, interface 2500 shows a second visualization 2510 of the flow data with a first set or source data and a second set of source data that can be displayed as a trellis of flows (two or more flows shown proximate one another) to compare data. In accordance with various other embodiments, trellising can occur in the vertical and/or horizontal direction depending on the precise needs of the data to be compared.

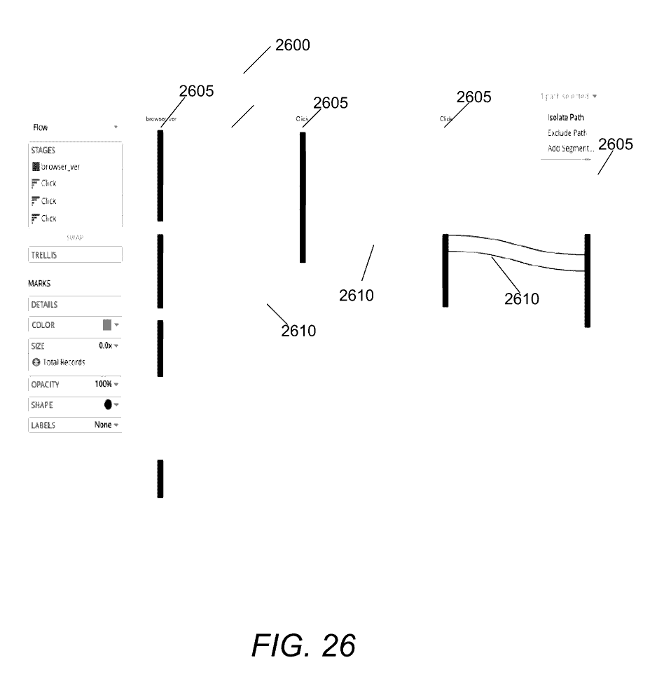

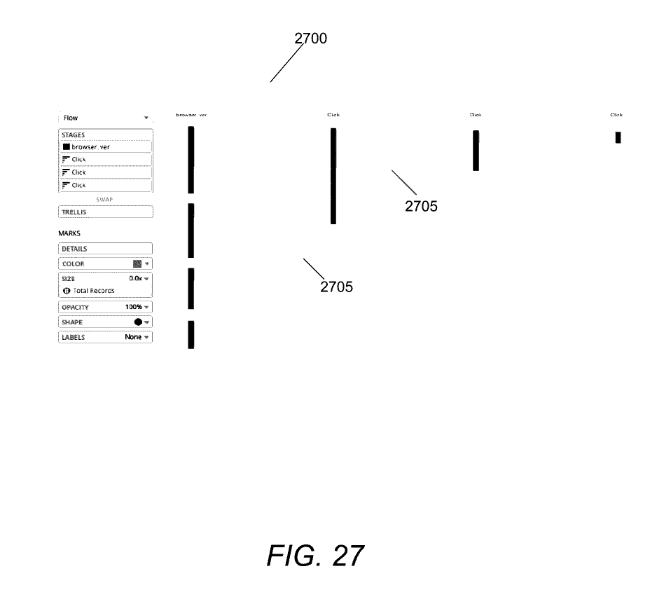

Interface 2600 shown in FIG. 26 shows an interface in which an isolation function is used to isolate a particular path to and/or from a particular attribute is shown. In the interface 2600, the path 2610 showing the path from a first attribute 2605 to fourth attribute 2605 is highlighted. The highlighted path shows all of the possible associations between the first attribute and the fourth attribute. The isolation function can be used to determine how the application of various attributes changes the amount of reporting data that can be applied by using a particular ordering of filters and/or dimensions to apply to the source data to obtain desired data. Interface 2700 shown in FIG. 27 shows an isolation of paths for another set of flow data. In the interface 2700, paths 2705 are highlighted for a user to show all of the possible associations between source data having a particular first attribute and a particular fourth attribute.

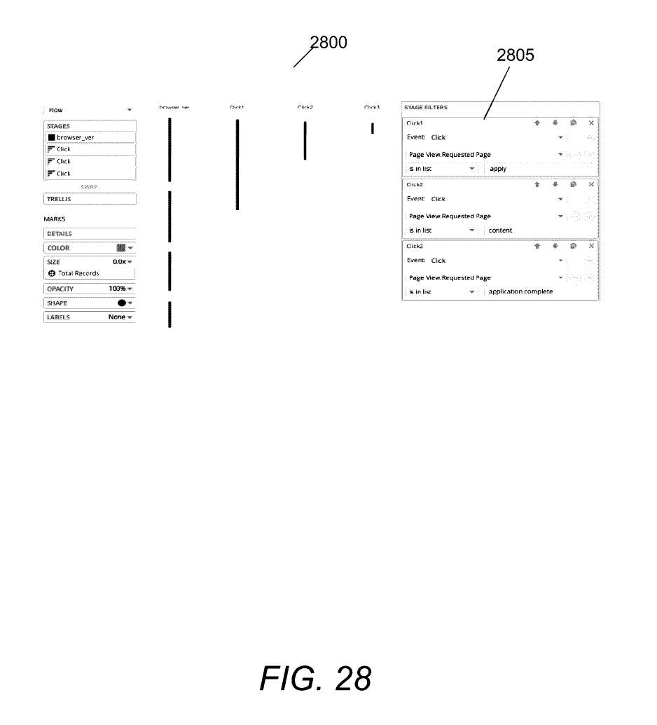

The interface 2800 shown in FIG. 28 includes a dialog box 2805 that allows a user to manipulate the attributes to change the visualization. This can include, but is not limited to, changing the orderings of the attributes in the flow visualizations. A user can use this function to change find the application of attributes in a particular order to obtain desired data from the source data.

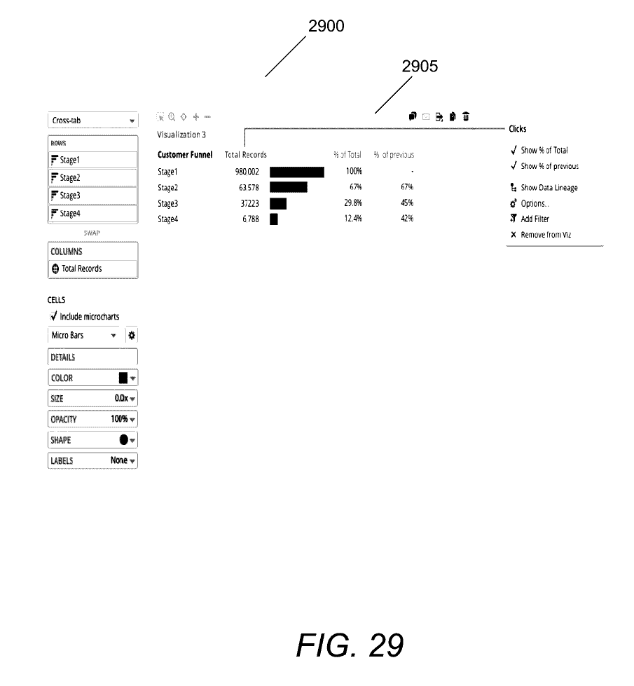

The interface 2900 shown in FIG. 29 includes alphanumeric descriptions 2905 of the results of applications of attributes are provided. The alphanumeric descriptions can allow a user to determine how the various attributes affect the flow of the source data. This can be used to determine an ordering of the attributes that provides the desired results concerning relevant information for a user.

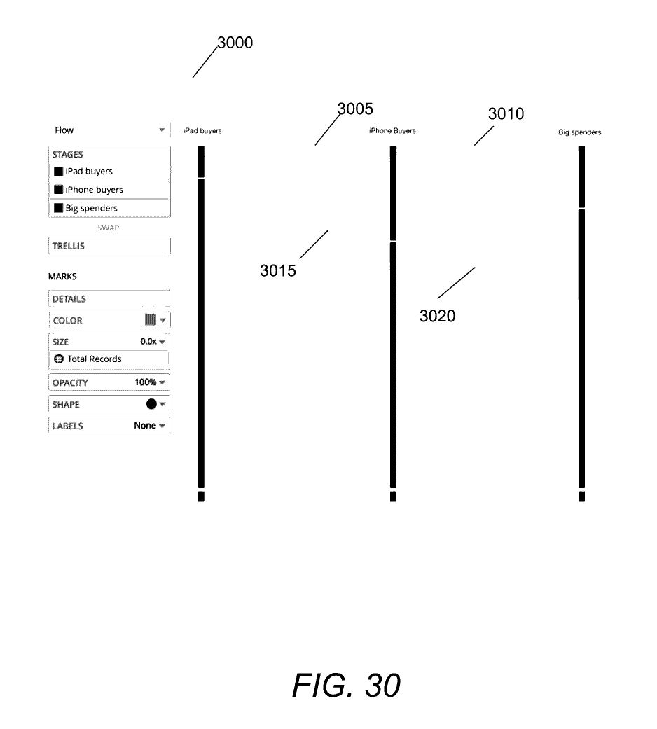

The interface 3000 shown in FIG. 30 is an interface for comparing a first path (segments 3005, 3010) and a second path (segments 3015, 3020) in the flow. The comparisons can be used to determine which attributes of the filters can be applied to obtain the most relevant data.

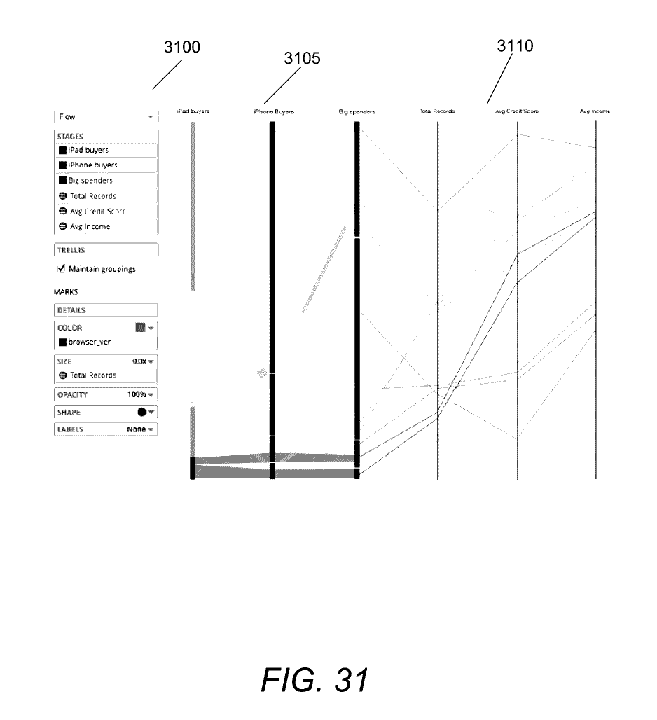

The interface 3100 shown in FIG. 31 includes a flow area 3105 that shows the various flows of data based on the application of attributes and a metrics area that shows metrics determined for each of the identified paths. These metrics can be useful in determining which path includes information about one or more desired portions of the source data to show which attributes provided desired information when applied to the source data.

### Process for Providing User Aid Based on Telemetry Data

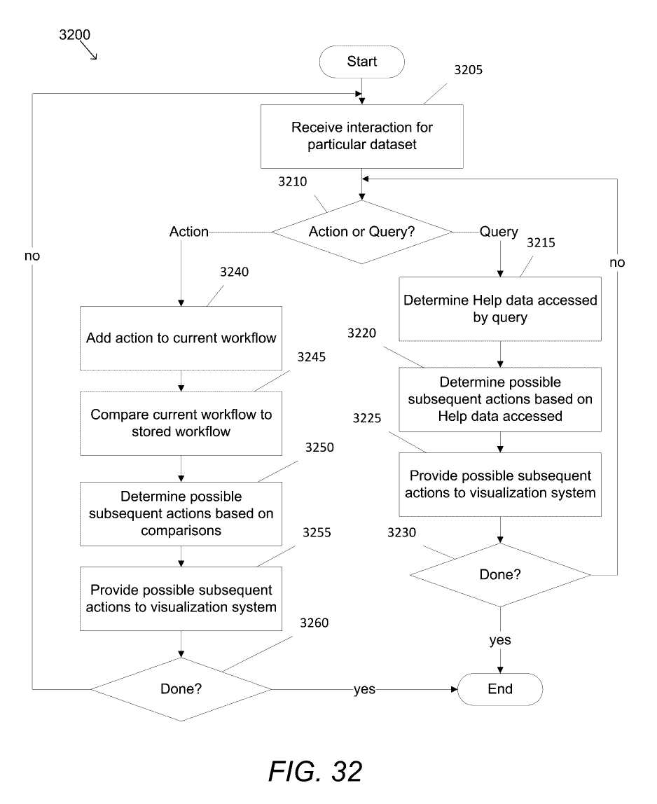

In accordance with some embodiments, the interest-driven business intelligence system provides suggestions to users to facilitate the user's manipulation of the data. To do so, interactions of the user with system are monitored and suggestions for subsequent interactions are provided. For purposes of this discussion, a chronological list of the interactions between the user and the system is referred to as telemetry and information about the telemetry is referred to as telemetry data. In accordance with some embodiments, the telemetry includes one or more workflows. A workflow is chronological listing of related interactions and workflow data is the data relating to a workflow. A process performed by an interest-driven business intelligence server system for providing suggestions about subsequent interactions based upon the telemetry of a user in accordance with an embodiment of the invention is shown in FIG. 32.

Process 3200 receives an interaction with a particular dataset by user from a visualization system (3205). In accordance with some embodiments, the visualization system can provide interaction to the interest-driven business intelligence server system as the interaction is requested. Alternatively, the visualization system can store the interactions and provide a set of interactions to interest-driven business intelligence server system periodically in accordance with some other embodiments.

The process 3200 determines whether the interaction is query or an action (3210). For purposes of this discussion, a query is an action that accesses a help data that provides information about interactions or functions available to the user and an action is an instruction that results in manipulation of the data. In accordance with some embodiments, actions includes, but are not limited to, additions and removals of information from an instructions such as, but not limited to, report data requirements, report data requests, segment grouping data, and segment data requests.

If the interaction is an action, process 3200 add the interaction to current workflow data (3240). In accordance with some embodiments, the current workflow data can be stored in a data structure that allows the workflow data to be traversed such that the user can move along the workflow to change the current state of the workflow within the chronological listing of related interactions in the workflow data of the current workflow. Examples of such data structures include linked list, trees, and any other data structures as appropriate to the requirements of specific applications of embodiments of the invention. The current workflow data is compared to previously stored workflow data (3245). The comparison can be performed by traverse previous workflow data to determine the similarity of the previous workflow data to the current workflow data. In accordance with some embodiments, the stored workflows used for comparison are previously stored workflows of the user. In accordance with some other embodiments, the stored workflows used for the comparisons are stored workflows of one or more users in a set of associated users that includes the current user. In accordance with still other embodiments, the stored workflows used for the comparisons are workflows of a set of users for the set of all users of the interest-driven business intelligence system. In a variety of embodiments, the workflows are stored in a global workflow database accessible by a variety of interest-driven business intelligence systems. In this way, stored workflows can be retrieved from the global workflow database and insights into the manipulation of data can be shared across a variety of interest-driven business intelligence systems.

Based on the comparisons, the process 3200 determines possible subsequent actions for the current workflow data (3250). The possible subsequent actions can be determined by the subsequent steps taken in portions of stored workflow data that is similar to the current workflow data. In accordance with some embodiments, more than one subsequent step can be recommended and the recommendations can be based upon the occurrence of the recommended subsequent steps in workflows with a portion of workflow data that is similar to the current workflow data. In accordance with a number of embodiments, the proximity of a subsequent action to the portion of a stored workflow data of a similar workflow can be used to determine the probability of an action as the next action to take for the current workflow based upon the current workflow data. The recommended subsequent actions are then provided to the visualization system for use in presenting recommendations to the user (3255). Process 3200 can then repeats when a next interaction is received.

If the received into action is determined to be a query, process 3200 determines the help data being accessed by the query (3215). Each particular piece of help data is associated with triggers for one or more particular actions. The triggers for each piece of help data can be stored in a library that is loaded at run time or dynamically depending on the embodiments of the invention. The subsequent actions to recommend are determined based upon the help data accessed (3220). In accordance by some embodiments, the subsequent actions to recommend are determined based upon the triggers associated with the help data accessed. The recommended subsequent actions are provided to the visualization system for use in presenting recommendations to the user (3230). Process 3200 then repeats when a next interaction is received.

Although a specific process for providing recommendations of subsequent interactions is described above with respect to FIG. 32, any of a variety of processes, including those that store segment data using alternative techniques to those described above, can be utilized in accordance with embodiments of the invention.

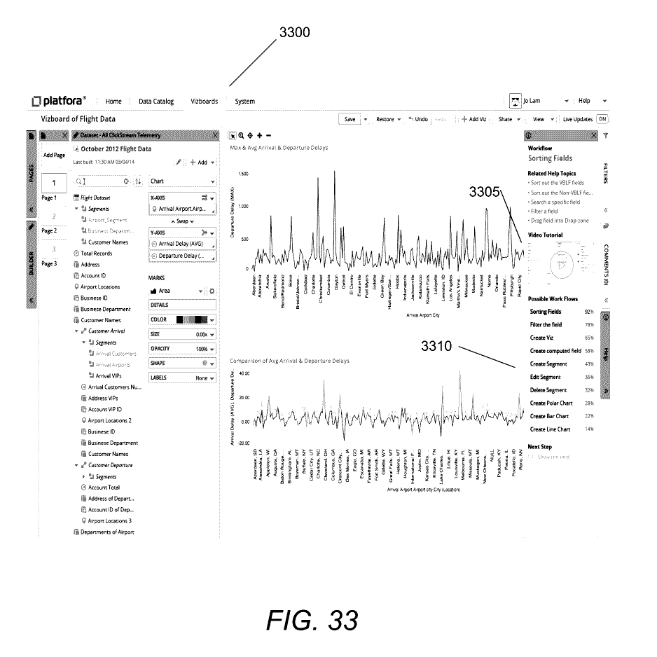

Examples of interfaces that provide recommendations of subsequent interactions generated by a process such as the process 3200 described above in accordance with some embodiments of the invention are shown in FIGS. 33 and 34. In interface 3300 shown in FIG. 33, a help tutorial 3305 is accessed by the user. In accordance with the various embodiments of the invention, the help tutorial 3305 can be accessed by the user and/or can be provided to the user by the system based upon the telemetry data of the current workflow. In response to the help tutorial being accessed and/or based on the telemetry data of the current workflow, a list of possible subsequent interactions and the likelihood of the use of each interaction is shown in suggestions area 3310. In interface 3400, the user has performed an action and the list of possible interactions is updated in area 3405. In addition, certain areas 3410 of the interface 3400 that can be used to perform the suggested interactions are highlighted to better help the user selected a desired interaction.

Although the present invention has been described in certain specific aspects, many additional modifications and variations would be apparent to those skilled in the art. In particular, any of the various processes described above can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An interest-driven business intelligence server system comprising:
a processor; and
a memory connected to the processor and configured to store an interest-driven business intelligence application;
wherein the interest-driven business intelligence application directs the processor to:
receive telemetry data from an interest-driven business intelligence visualization system wherein the telemetry data includes an action for manipulating data,
add the telemetry data for the action to current workflow data wherein the current workflow data includes a sequential list of actions performed on the data,
compare the current workflow data to stored workflow data,
determine one or more possible subsequent actions to perform on the data based upon the comparison of the current workflow data to stored workflow data wherein the stored workflow data includes workflow data for a plurality of workflows, and
provide the one or more possible subsequent actions to perform on the data to the interest-driven business intelligence visualization system.

2. The interest-driven business intelligence server system of claim 1, wherein the determination of the one or more subsequent action includes:
determine each workflow in the stored workflow data that includes a portion of workflow data that is similar to the current workflow data and determine actions with the workflow data after the portions of workflow data that is similar to the current workflow data, and
provide the subsequent actions in the workflow data of each workflow having a portion of workflow data similar to the current workflow data as a possible subsequent action for the current workflow data.

3. The interest-driven business intelligence server system of claim 1, wherein the stored workflow data includes workflow data from previous workflows of a user.

4. The interest-driven business intelligence server system of claim 2, wherein the stored workflow data includes workflow data of previous workflows of users associated with the user.

5. The interest-driven business intelligence server system of claim 2, wherein the stored workflow data includes workflow data of previous workflows of a plurality of users.

6. The interest-driven business intelligence server system of claim 2, wherein the one or more subsequent actions are ranked based upon likelihood of use.

7. The interest-driven business intelligence server system of claim 6, wherein the ranking of each of the one or more subsequent actions is based upon the proximity of each of the one or more subsequent actions in the workflow data of a workflow to a portion of workflow data for the workflow that is similar to the current workflow data.

8. The interest-driven business intelligence server system of claim 6, wherein the ranking of each of the one or more subsequent actions is based upon a number of occurrences of each of the one or more subsequent steps in the stored workflow data.

9. The interest-driven data visualization system of claim 1, wherein the interest-driven business intelligence application further direct the processor to:
determine whether the interaction is a query,
determine help data accessed by the query in response to a determination that the interaction is a query,
determine one or more possible subsequent actions to perform on the data based upon the help data accessed by the query, and
provide the one or more possible subsequent actions to perform on the data to the interest-driven business intelligence visualization system.

10. The interest-driven business intelligence server system of claim 1, wherein the interest-driven business intelligence application directs the processor to obtain the stored workflow data from a global workflow database.

11. A method performed by interest-driven business intelligence server system, comprising:
receiving telemetry data from an interest-driven business intelligence visualization system wherein the telemetry data includes actions that manipulate data;
adding the telemetry data to current workflow data wherein the current workflow data includes a sequential list of actions performed on the data;
comparing the current workflow data to stored workflow data;
determining one or more possible subsequent actions to perform on the data based upon the comparison of the current workflow data to stored workflow data wherein the stored workflow data includes workflow data for a plurality of workflows; and
providing the one or more possible subsequent actions to perform on the data to the interest-driven business intelligence visualization system.

12. The method of claim 11, wherein the determining of the one or more subsequent action comprises:
determining each workflow in the stored workflow data that includes a portion of workflow data that is similar to the current workflow data and determine actions with the workflow data after the portions of workflow data that is similar to the current workflow data; and
providing the subsequent actions in the workflow data of each workflow having a portion of workflow data similar to the current workflow data as a possible subsequent action for the current workflow data.

13. The method of claim 12, wherein the stored workflow data includes workflow data from previous workflows of a user.

14. The method of claim 12, wherein the stored workflow data includes workflow data of previous workflows of users associated with the user.

15. The method of claim 12, wherein the stored workflow data includes workflow data of previous workflows of a plurality of users.

16. The method of claim 12, wherein the one or more subsequent actions are ranked based upon likelihood of use.

17. The method of claim 16, wherein the ranking of each of the one or more subsequent actions is based upon the proximity of each of the one or more subsequent actions in the workflow data of a workflow to a portion of workflow data for the workflow that is similar to the current workflow data.

18. The method of claim 16, wherein the ranking of each of the one or more subsequent actions is based upon a number of occurrences of each of the one or more subsequent steps in the stored workflow data.

19. The method of claim 11, further comprising:
determining whether the interaction is a query;
determining help data accessed by the query in response to a determination that the interaction is a query;
determining one or more possible subsequent actions to perform on the data based upon the help data accessed by the query; and
providing the one or more possible subsequent actions to perform on the data to the interest-driven business intelligence visualization system.

20. The method of claim 11, further comprising obtaining the stored workflow data from a global workflow database.
